(19) United States
(12) Patent Application Publication
(10) Pub. No.: US 2013/0249896 A1
(43) Pub. Date: Sep. 26, 2013

(54) METHOD OF DISPLAYING THREE-DIMENSIONAL STEREOSCOPIC IMAGE AND DISPLAY APPARATUS PERFORMING THE METHOD

(71) Applicant: Goro HAMAGISHI, Hwaseong-si (KR)

(72) Inventor: Goro HAMAGISHI, Hwaseong-si (KR)

(73) Assignee: Samsung Display Co., Ltd., Yongin-City (KR)

(21) Appl. No.: 13/610,823

(22) Filed: Sep. 11, 2012

(30) Foreign Application Priority Data
Mar. 22, 2012 (KR) 10-2012-0029487

(51) Int. Cl. G06T 15/00; G09G 5/00

(52) U.S. Cl. 345/419; 345/204

(57) ABSTRACT

A method of displaying three-dimensional stereoscopic image includes displaying N viewpoint images on N sub-pixels, emitting the N viewpoint images through a dynamic conversion panel on which a emission unit is defined, controlling a sub-area to emit the N viewpoint images onto N×M viewpoint positions if observers are plural, and moving the emission unit to a position determined according to an observer's position if the observer is single, and then emitting the N viewpoint images to the observer's position. The dots are consecutive in a row direction of a display panel. The emission unit includes a constituent emission unit consisting of M sub-areas. The display quality of three-dimensional stereoscopic images may be improved by detecting the number of observers and then driving in a multi-viewpoint mode or a tracking mode according to the number of the observers.

### CROSS-REFERENCE TO RELATED APPLICATION

This application claims priority from and the benefit of Korean Patent Application No. 10-2012-0029487, filed on Mar. 22, 2012, which is hereby incorporated by reference for all purposes as if fully set forth herein.

### DISCUSSION OF THE BACKGROUND

1. Field

Exemplary embodiments of the present invention relate to a method of displaying three-dimensional stereoscopic image and display apparatus performing the method.

2. Discussion of the Background

Generally, liquid crystal display apparatuses display two-dimensional planar images. Recently, the demand for liquid crystal display apparatuses that can display three-dimensional stereoscopic images has increased in various industry fields, such as games, movies, etc.

Generally, three-dimensional stereoscopic images are displayed by using a principle of binocular parallax through human eyes. For example, images observed from different angles through each eye are input to human brain because human eyes are spaced apart. Stereoscopic image displaying apparatuses use the principle of binocular parallax.

There are stereoscopic methods and autostereoscopic methods that use the binocular parallax. The stereoscopic methods include an anaglyph method and a shutter glass method. The anaglyph method uses glasses having blue and red lenses. The shutter glass method uses glasses that selectively prevent light from reaching the left and right eyes of a user in synchronization with when left eye images and right eye images are displayed.

The autostereoscopic methods include lens methods and barrier methods. A display apparatus employing the lens method includes lens panel disposed on a display panel. The lens panel displays a three-dimensional stereoscopic image by refracting the three-dimensional stereoscopic image displayed on the display panel to a plurality of viewpoints. A display apparatus employing the barrier method includes a barrier panel disposed on a display panel. The barrier panel displays a three-dimensional stereoscopic image by emitting the three-dimensional stereoscopic image displayed on the display panel to a plurality of viewpoints.

Recently, techniques to form the lens panel and the barrier panel as a liquid crystal panel are being developed to selectively display two-dimensional images and three-dimensional images.

### BRIEF SUMMARY OF THE INVENTION

Exemplary embodiments of the present invention relate to a method of displaying three-dimensional stereoscopic images by detecting observers and then selectively driving a multi-viewpoint mode and tracking mode, in order to improve the display quality of the three-dimensional stereoscopic images. Exemplary embodiments of the present invention also provide a display apparatus to perform the method.

Exemplary embodiments of the present invention provide a method of displaying three-dimensional stereoscopic image that includes displaying N viewpoint images on N dots, emitting the N viewpoint images through a dynamic conversion panel on which a emission unit is defined, controlling a sub-area to emit the N viewpoint images onto N×M viewpoint positions if multiple observers are detected, moving the emission unit to a position determined according to an observer's position if the observer is single, and emitting the N viewpoint images to the observer's position. The dots are consecutive in a row direction of a display panel. The emission unit includes an emission unit including of M sub-areas. M and N are natural numbers.

Exemplary embodiments of the present invention provide a display apparatus that includes a display panel to display N viewpoint images on N dots, and a dynamic conversion panel on which an emission unit is defined. The dots are consecutive in a row direction. The emission unit includes an emission unit including M sub-areas. The dynamic conversion panel controls the sub-areas to drive in a multi-viewpoint mode which N viewpoint images are emitted to N×M viewpoint positions if observers are plural. The dynamic conversion panel moves the emission unit to a position determined according to an observer's position to drive in a tracking mode which N viewpoint images are emitted to the observer's position if the observer is single. M and N are natural numbers.

According to various embodiments, the display quality of three-dimensional stereoscopic images may be improved by detecting the number of observers and then driving in a multi-viewpoint mode or a tracking mode according to the number of the observers.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram of display apparatus according to an exemplary embodiment of the present invention.

FIG. 2 is a cross-sectional view illustrating an emission unit included in the dynamic conversion panel of FIG. 1.

FIGS. 3A and 3B are plan views illustrating shapes of the emission units of the dynamic conversion panel of FIG. 1.

FIG. 4 is a flow diagram illustrating a method of driving the display apparatus of FIG. 1.

FIG. 5 is a cross-sectional view illustrating a dynamic conversion liquid crystal lens panel according to another exemplary embodiment of the present invention.

FIG. 6 is a cross-sectional view illustrating a liquid crystal lens panel according to is another exemplary embodiment of the present invention.

FIGS. 7A and 7B are cross-sectional views illustrating multi-viewpoint driving of the liquid crystal lens panel of FIG. 6.

FIG. 8 is a cross-sectional view illustrating a liquid crystal lens panel according to still another exemplary embodiment of the present invention.

FIGS. 9A and 9B are cross-sectional views illustrating multi-viewpoint driving of the liquid crystal lens panel of FIG. 8.

FIG. 10 is a cross-sectional view illustrating a liquid crystal lens panel according to still another exemplary embodiment of the present invention.

FIGS. 11A and 11B are cross-sectional views illustrating multi-viewpoint driving of the liquid crystal lens panel of FIG. 10.

FIG. 12 is a cross-sectional view illustrating a liquid crystal lens panel according to still another exemplary embodiment of the present invention.

FIGS. 13A and 13B are cross-sectional views illustrating multi-viewpoint driving of the liquid crystal lens panel of FIG. 10.

FIG. 14 is a luminance profile of three-dimensional stereoscopic images formed by the liquid crystal lens panel of FIG. 6.

FIG. 15 is a cross-sectional view illustrating a tracking mode using the liquid crystal lens panel of FIG. 6, when an observer is located within an observation distance.

FIG. 16 is a cross-sectional view illustrating a tracking mode using the liquid crystal lens panel of FIG. 6, when the observer's position is located beyond the observation distance.

FIG. 17 is a plan view of an observer screen according to the tracking mode of FIG. 16.

FIG. 18 is a timing chart illustrating the control of the position of a lens structure corresponding to the observer screen of FIG. 17.

FIG. 19 is a timing chart illustrating the control of the position of a lens structure corresponding to an observer screen, according to another exemplary embodiment of the present invention.

FIG. 20 is a cross-sectional view illustrating a tracking mode of a liquid crystal lens panel according to still another exemplary embodiment of the present invention when the observer's position is located beyond the observation distance.

FIG. 21 is a plan view of the observer screen according to the tracking mode of FIG. 20.

FIG. 22 is a timing chart illustrating the control of the position of a lens structure corresponding to the observer screen of FIG. 20.

FIG. 23 is a timing chart illustrating the control of the position of a lens structure corresponding to an observer screen according to still another exemplary embodiment of the present invention.

FIG. 24 is a luminance profile of three-dimensional stereoscopic images according to the liquid crystal lens panel of FIG. 10.

FIG. 25 is a plan view of the observer screen according to the liquid crystal lens panel of FIG. 10.

FIG. 26 is a timing chart illustrating the control of the position of a lens structure corresponding to the observer screen of FIG. 25.

FIG. 27 is a cross-sectional view illustrating a tracking mode of a liquid crystal is lens panel according to still another exemplary embodiment of the present invention when an observer is located within an observation distance.

FIG. 28 is a cross-sectional view of a dynamic conversion panel of liquid crystal barrier type according to still another exemplary embodiment of the present invention.

FIG. 29 is a cross-sectional view of a liquid crystal barrier panel according to still another exemplary embodiment of the present invention.

FIG. 30 is a cross-sectional view illustrating multi-viewpoint driving type of the liquid crystal barrier panel of FIG. 29.

FIG. 31 is a cross-sectional view of a liquid crystal barrier panel according to still another exemplary embodiment of the present invention.

FIG. 32 is a cross-sectional view illustrating multi-viewpoint driving type of the liquid crystal barrier panel of FIG. 31.

FIG. 33 is a cross-sectional view of a liquid crystal barrier panel according to still another exemplary embodiment of the present invention.

FIG. 34 is a cross-sectional view illustrating multi-viewpoint driving type of the liquid crystal barrier panel of FIG. 33.

FIG. 35 is a cross-sectional view illustrating a tracking mode according to the liquid crystal barrier panel of FIG. 29 when the observer is located within the observation distance.

FIG. 36 is a cross-sectional view illustrating a tracking mode according to the liquid crystal barrier panel of FIG. 33, when the observer is located within the observation distance.

FIG. 37 is a timing chart illustrating the control of the position of a barrier unit corresponding to the observer screen according to the liquid crystal barrier panel of FIG. 30 when observed by an observer located far away.

FIG. 38 is a timing chart illustrating the control of the position of a barrier unit corresponding to an observer screen according to still another exemplary embodiment of the present invention.

FIG. 39 is a timing chart illustrating the control of the position of a barrier unit corresponding to the observer screen according to the liquid crystal barrier panel of FIG. 33 when observed by an observer.

FIG. 40 is a perspective view of display apparatus according to another exemplary embodiment of the present invention.

FIG. 41 is a cross-sectional view illustrating a emission unit included in the dynamic conversion panel of FIG. 40.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other is element or layer, or intervening elements or layers may be present. In contrast, when an element is referred to as being “directly on” or “directly connected to” another element or layer, there are no intervening elements or layers present.

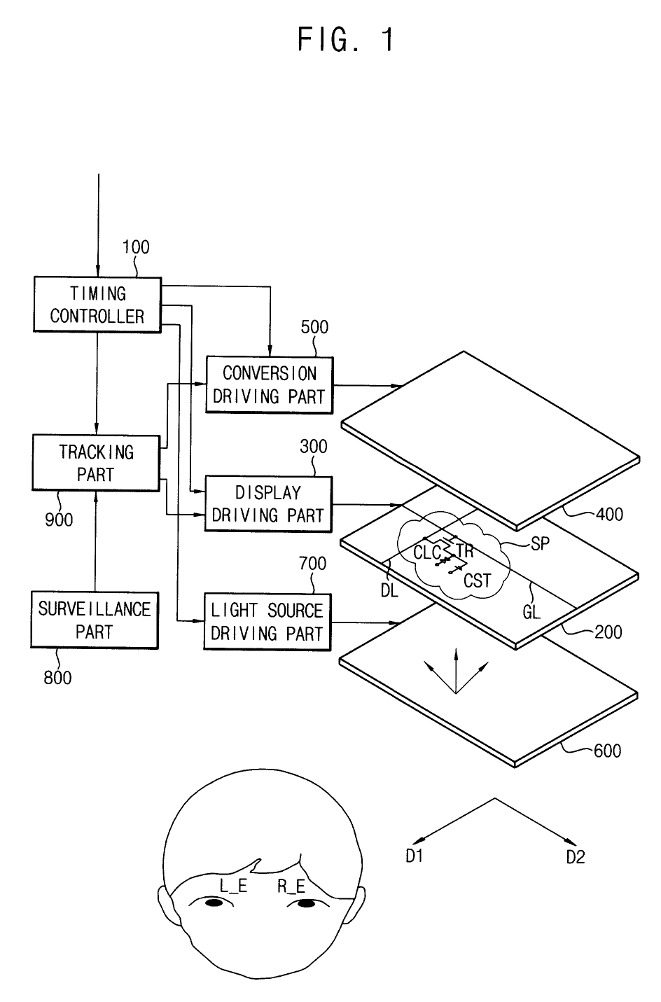

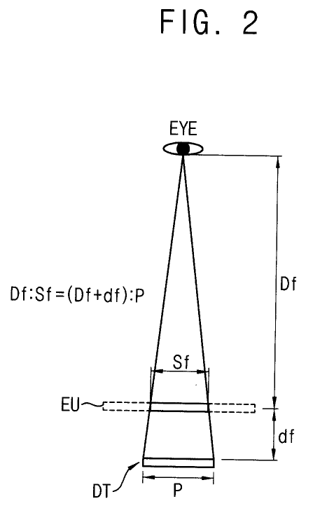

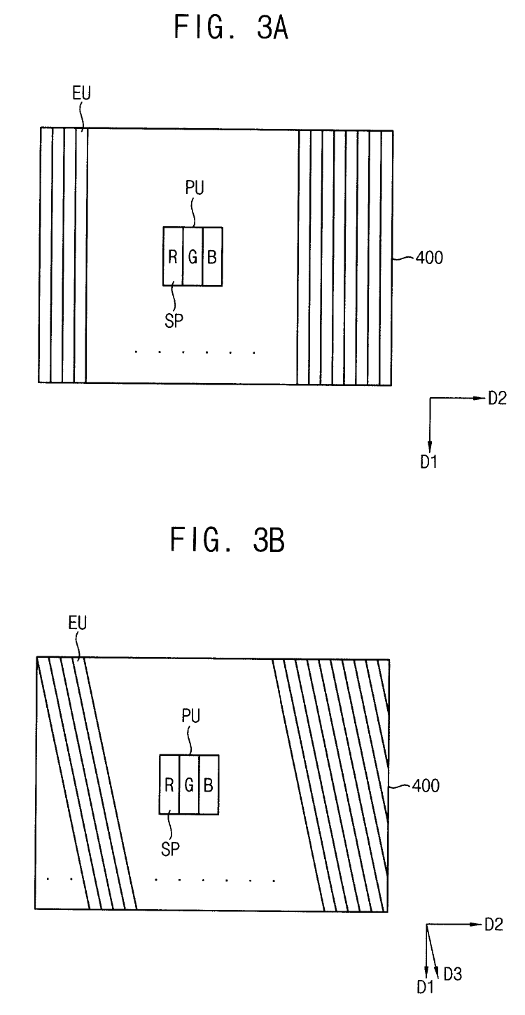

FIG. 1 is a block diagram of display apparatus according to an exemplary embodiment of the present invention. FIG. 2 is a cross-sectional view illustrating an emission unit (viewing unit) included in the dynamic conversion panel of FIG. 1. FIGS. 3A and 3B are plan views illustrating shapes of the emission units of the dynamic conversion panel of FIG. 1.

Referring to FIGS. 1, 2, 3A, and 3B, the display apparatus includes a controller 100, a display panel 200, a display driver 300, a dynamic conversion panel 400, a conversion driver 500, a light source 600, a light source driver 700, a surveillance part 800, and a tracker 900. The controller 100 receives two-dimensional image data and three-dimensional image data, and controls the driving of each component of the display apparatus in a two-dimensional image mode or a three-dimensional image mode, on the basis of the received image data.

The controller 100 controls an operating mode of the dynamic conversion panel 400 according to the image modes. For example, the controller 100 drives the dynamic conversion panel 400 in a transmission mode, in order to emit two-dimensional images displayed on the display panel 200 during the two-dimensional image mode. The controller 100 drives the dynamic conversion panel 400 in a conversion mode in order to emit three-dimensional images displayed on the display panel 200 to at least two viewpoint positions in the three-dimensional image mode.

In addition, the controller 100 may drive the dynamic conversion panel 400 in a multi-viewpoint mode when there are multiple observers, or in a tracking mode when there is only one observer is single, in the three-dimensional image mode. The dynamic conversion is panel 400 emits the three-dimensional images displayed on the display panel 200 to a plurality of viewpoint positions in the multi-viewpoint mode. The dynamic conversion panel 400 emits the three-dimensional images displayed on the display panel 200 to the position of the observer in the tracking mode.

The controller 100 may correct the image data using various correction algorithms. For example, the adaptive color correction (ACC) may be performed to uniformly correct white levels of the image data. Also, the dynamic capacitance compensation (DCC) may be performed to correct the image data of a current frame, on the basis of image data of a previous frame, in order to improve the response speed of the current frame with respect to the previous frame.

In addition, the controller 100 may render the three-dimensional image to fit the viewpoint of the observer in the tracking mode, if the observer is located beyond a designed observation distance.

The display panel 200 includes a plurality of data lines DL, a plurality of gate lines GL, and a plurality of subpixels SP. The data lines DL extend in a first direction D1 and are arranged in a second direction D2 crossing the first direction D1. The gate lines GL extend in the second direction D2 and are arranged in the first direction D1. The subpixels SP may be arranged in a matrix including a plurality of pixel rows and columns, and may be an elementary unit of the display panel 200. Each subpixel SP includes a switching element TR connected to the data lines DL and the gate lines GL, and a pixel electrode PE connected to the switching element TR. The display panel 200 includes a plurality of unit pixels PU including at least one of the subpixels SP. For example, the unit pixel PU may include red R, green G, and blue B subpixels.

The display panel 200 displays viewpoint images to an observer. A viewpoint is image is formed by dots DT formed by the display panel 200. A dot DT may emitted by at least one of the subpixels SP. A dot group includes N dots where N is a natural number greater than one. The dot group is an elementary unit of the display panel 200 displaying N viewpoint images. For example, a dot group is used to form each viewpoint image.

The display driver 300 drives the display panel 200 according to the control of the controller 100. The display driver 300 may include a data driver to drive the data lines DL, and a gate driver to drive the gate lines GL.

The dynamic conversion panel 400 forms a plurality of emission units EU that emit three-dimensional images displayed on the display panel 200 to at least two viewpoint positions, in the three-dimensional image mode. Each emission unit EU is an elementary unit through which N viewpoint images are emitted. Each emission unit EU includes N emission areas. Each emission area is an area through which one viewpoint image is emitted. A sub-area is an elementary unit of the emission area. The emission area includes M sub-areas where M is a natural number greater than one.

Referring to FIG. 2, the emission unit EU includes at least one unit area Sf. The unit area Sf is an area which the emission unit EU is movable. The unit area Sf corresponds to one dot DT. The unit area Sf may be determined by a pitch of the dots DT, a distance df between the dot DT and the emission unit EU, and an observation distance Df set for the emission unit EU.

Df:Sf=(Df+Sf):p [Equation 1]

Referring to FIG. 3A, the emission units EU extend in the first direction D1 and are arranged to the second direction D2 as a striped structure. In contrast, referring to FIG. 3B, is the emission units EU may extend in a third direction D3 crossing the first direction D1 and the second direction D2, and may be arranged in the second direction D2, as a tilted structure.

The conversion driver 500 provides driving voltages to element electrodes of the dynamic conversion panel 400, according to the control of the controller 100. The conversion driver 500 adjusts the viewpoint images to at least four viewpoint positions, by moving the position of the emission unit including M sub-emission units in a multi-viewpoint mode, where M is a natural number. The conversion driver 500 directs the viewpoint images to the observer's position by moving the emission units to according to the observer's position.

The light source 600 may include an edge-illumination light source or a direct-illumination light source. The edge-illumination light source includes at least one light source is disposed on an edge of a light guide plate, which is disposed under the display panel 200. The direct-illumination light source includes at least one light source is disposed directly under the display panel 200 and does not include the light guide plate is omitted.

The light source driver 700 controls the operation of the light source 600 according to a control of the controller 100. The surveillance part 800 detects at least one observer and provides surveillance data to the tracking part 900. In particular, the surveillance part 800 detects the position of the head or eyes of the observer. The surveillance part 800 may be a camera.

The tracking part 900 detects the number of observers and information on the observers' positions on the basis of the surveillance data. The tracking part 900 tracks the position of the observers on the basis of the surveillance data provided from the surveillance part 800 in the tracking mode. The tracking part 900 may track the observer's position by recognizing an angle of the observer with respect to the display apparatus. The tracking part 900 provides the is information on the observer's position to the controller 100.

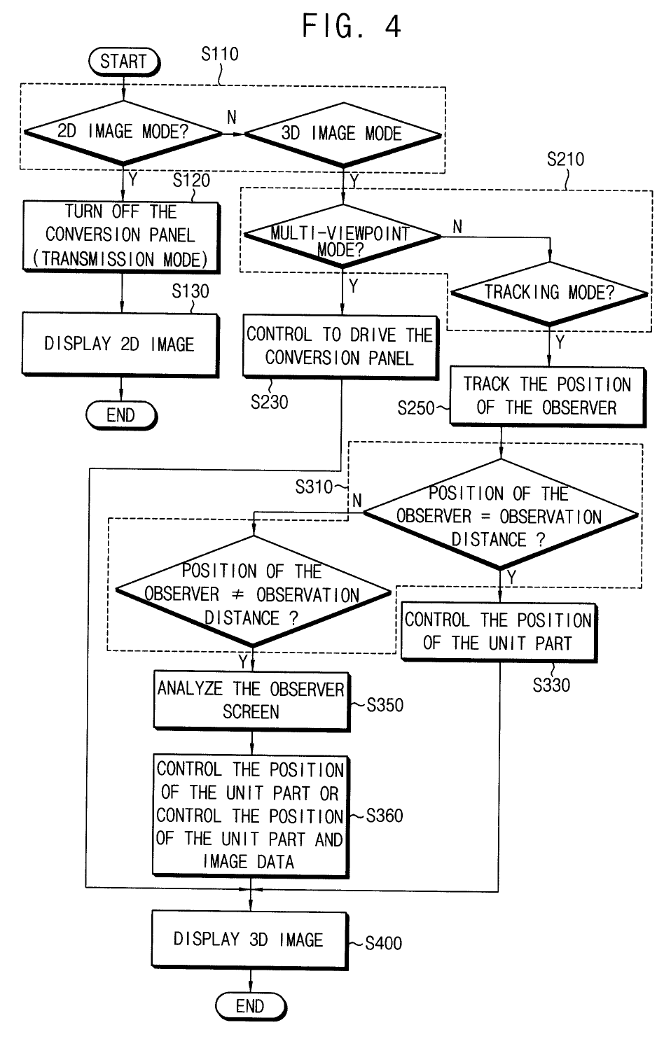

FIG. 4 is a flow diagram illustrating a method of driving the display apparatus of FIG. 1. Referring to FIG. 1 and FIG. 4, in step S110, the controller 100 determines whether the received image data is two-dimensional image data or three-dimensional image data.

If the received image data is two-dimensional image data, the controller 100 drives the display apparatus in a two-dimensional image mode. In a step S120, the conversion driver 500 drives the dynamic conversion panel 400 in a transmission mode, according to the control of the controller 100. For example, the conversion driver 500 prevents driving voltages from being applied to the dynamic conversion panel 400. In step S130, the display driver 300 displays two-dimensional images on the display panel 200, according to the control of the controller 100. Accordingly, the two-dimensional images displayed on the display panel 200 are transmitted through the dynamic conversion panel 400 during the transmission mode. As a result, an observer may receive two-dimensional images.

If the received image data is three-dimensional image data, the controller 100 drives the display apparatus in a three-dimensional image mode. In the three-dimensional image mode, the controller 100 sets the driving mode as a multi-viewpoint mode or a tracking mode, according to the number of observers viewing the display apparatus, in step S210. For example, if multiple observers are detected, the controller 100 drives the display apparatus in the multi-viewpoint mode, while if only one observer is detected, the controller 100 drives the display apparatus in the tracking mode.

In the multi-viewpoint mode, the conversion driver 500 controls the emission units EU of the dynamic conversion panel 400, according to the control of the controller 100, in step S230. For example, if the dynamic conversion panel 400 is a liquid crystal lens panel that is includes a lens and M lens electrodes, where M is a natural number greater than one, then the lens structure is moved M times by a unit of one lens electrode, during one frame. That is, the sub-area corresponds to the area on which the lens electrode is formed. The display driver 300 displays the three-dimensional image data on the display panel 200 according to the control of the controller 100, in step S400.

In addition, if the dynamic conversion panel 400 is a liquid crystal barrier panel driven as a barrier unit which includes an emission unit (opening) consisting of M sub-areas, then the barrier unit is driven such that a dot is emitted from a corresponding emission unit instep S400. Accordingly, at least two observers may receive three-dimensional stereoscopic images.

In the tracking mode, the tracking part 900 tracks the position of an observer using the surveillance data provided from the surveillance part 800, in step S250. The tracking part 900 provides information on the observer's position to the controller 100.

The controller 100 compares the observer's position with the observation distance, on the basis of the information on the position. If the observer's position is substantially the same as the observation distance, then the conversion driver 500 controls the position of the emission units by a unit of the sub-areas, according to the control of the controller 100, in step S330. That is, each emission unit is moved in a right-and-left direction by a unit of the sub-area, according to a moving direction of the observer.

For example, when the emission unit of the dynamic conversion panel 400 includes M sub-areas, the emission unit is moved according to a moving direction of the observer by one sub-area, if the observer moves more than ±E/(2M) in a row direction, where E is the distance between a left eye and a right eye of the observer. In addition, if the observer moves by E/2 in a row direction, then the emission unit is moved in the moving direction of the observer by one sub-area. The display driver 300 displays the three-dimensional image data on the display panel 200 according to the control of the controller 100.

In step S350, if the observer's position is located beyond the observation distance, the controller 100 analyzes an observer screen approximating an image observed at the observer's position. The controller 100 divides the dynamic conversion panel 400 into a plurality of areas on the basis of viewpoint images (e.g., left-eye images or right-eye images) included in the observer screen and mixed images, and controls the positions of the emission units of the dynamic conversion panel 400 in each area. In step S360, the conversion driver 500 controls the position of the emission units included in each area according to the control of the controller 100.

In step S400, the three-dimensional image data are displayed on the display panel 200 according to the control of the controller 100.

Alternatively, the controller 100 divides the dynamic conversion panel 400 into a plurality of areas on the basis of the observer screen, and divides the plurality of areas into two groups. In step S360, the controller 100 moves the emission units of a first group of areas corresponding to viewpoint images (e.g., left-eye images or right-eye images) to a first position, and moves the emission units of a second group of areas corresponding to mixed areas, to a second position moved by a distance determined with respect to the first position. In addition, the controller 100 renders image data to display a normal viewpoint image in an area on which another viewpoint image among the first group of areas is displayed, and in an area on which another viewpoint image among the second group of areas is displayed. The conversion driver 500 controls the position of the emission units included in each area, according to the control of the controller 100. The display driver 300 drives the display panel 200 using the rendered image data provided from the controller 100, in step S400.

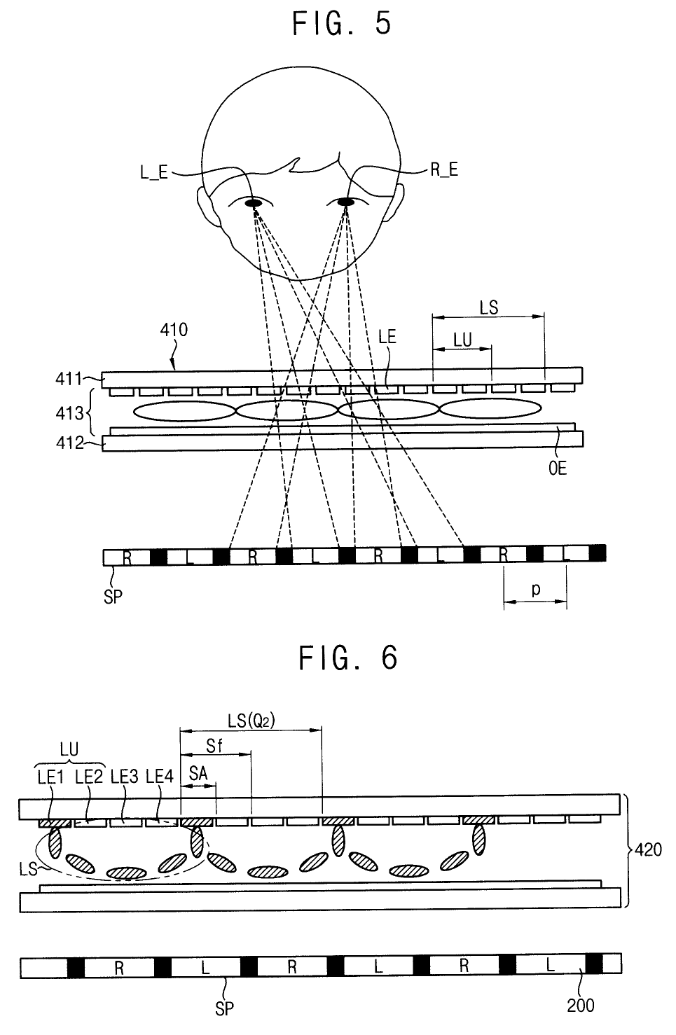

FIG. 5 is a cross-sectional view illustrating a dynamic conversion liquid crystal lens panel 410, according to another exemplary embodiment of the present invention. Referring to FIG. 5 and FIG. 6, the liquid crystal lens panel 410 includes a first substrate 411, a second substrate 412, and a liquid crystal layer 413.

The first substrate 411 includes a plurality of lens electrodes LE. The second substrate 412 includes a counter electrode OE that faces the lens electrodes LE. The liquid crystal layer 413 forms a plurality of lens structures LS in response to a voltage applied to the lens electrodes LE and the counter electrode OE. Each lens structure LS corresponds to an emission unit EU, as described above.

If the liquid crystal lens panel 410 is for N viewpoint images, each lens structure LS may include N lens units LU. Each lens unit LU is an elementary unit used to form a viewpoint image. The lens units LU may include M lens electrodes LE. The area on which each lens electrode LE is formed corresponds to a sub-area SA described above. Thus, each lens unit LU includes M sub-areas SA (i.e., M×SA).

In FIG. 5, although the first substrate 411 is disposed above the second substrate 412, the positions of the first and the second substrates 411, 412 are not limited thereto.

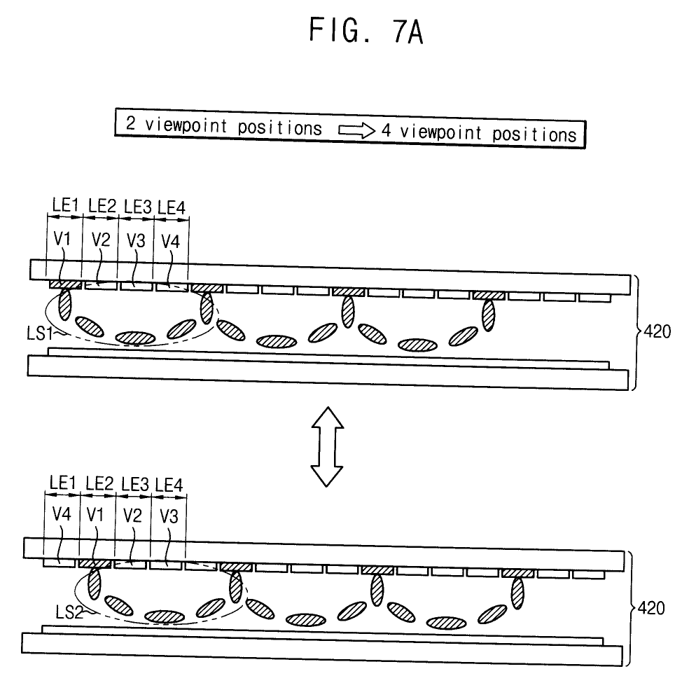

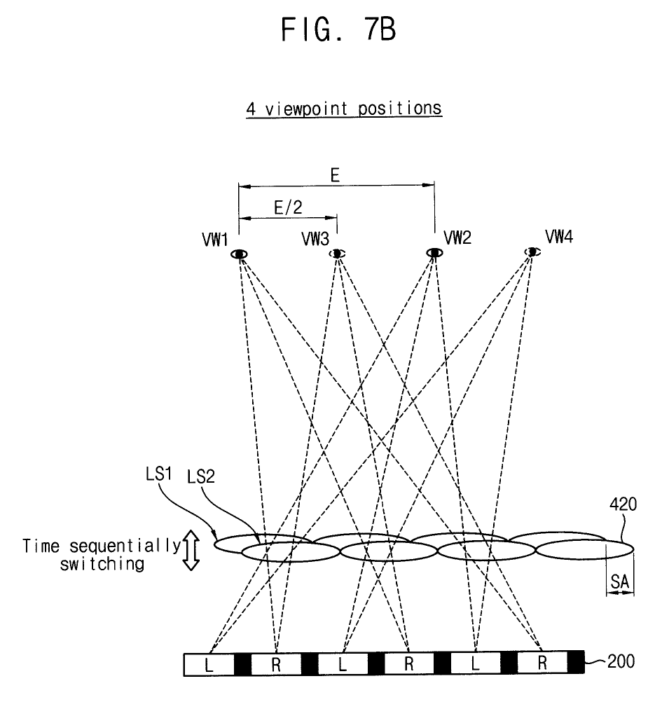

FIG. 6 is a cross-sectional view illustrating a liquid crystal lens panel, according to another exemplary embodiment of the present invention. FIGS. 7A and 7B are cross-sectional views illustrating multi-viewpoint driving of the liquid crystal lens panel of FIG. 6.

Referring to FIG. 6, the liquid crystal lens panel includes a plurality of lens structures LS for two viewpoints. Each lens structure LS includes two lens units LU. Each lens c unit LU includes two lens electrodes, for example lens electrodes LE1, LE2. Accordingly, the lens structure LS may include four lens electrodes LE1, LE2, LE3, and LE4 to project two is viewpoint images. A unit area Sf includes two sub-areas (i.e., 2×SA) corresponding to the number of lens electrodes included in each lens unit LU. The length Q2 of the lens structure LS is approximately twice the length of the unit area Sf.

The display panel 200 corresponding to the liquid crystal lens panel 420 displays two viewpoint images (i.e., left-eye image L and right-eye image R) for every two subpixels, which are consecutive in a row direction. In a multi-viewpoint mode, the method of driving the liquid crystal lens panel 420 is performed as follows.

Referring to FIGS. 1, 7A, and 7B, the conversion driver 500 applies a first driving voltage V1, a second driving voltage V2, a third driving voltage V3, and a fourth driving voltage V4 to the first lens electrode LE1, the second lens electrode LE2, the third lens electrode LE3, and the fourth lens electrode LE4, respectively, during a first interval of a frame. Accordingly, the liquid crystal lens panel 420 operates as a first lens structure LS 1, and emits two viewpoint images displayed on the display panel 200 to a first viewpoint position VW1 and a second viewpoint position VW2, during the first interval of the frame.

Then, the conversion driver 500 applies shifted voltages (e.g., the fourth, the first, the second, and the third driving voltages V4, V1, V2, V3) to the first, the second, the third, and the fourth lens electrodes LE1, LE2, LE3, LE4, respectively, during a second interval of the frame. Accordingly, the liquid crystal lens panel 420 operates as a second lens structure LS2, which is moved by the width of one lens electrode, with respect to the first lens structure LS1, and emits two viewpoint images displayed on the display panel 200 to a third viewpoint position VW3 and a fourth viewpoint position VW4, during the second interval of the frame. The liquid crystal lens panel 420 may sequentially operate as the first and the second lens structures LS1, LS2 during a frame, to emit the total of four viewpoint images during the frame.

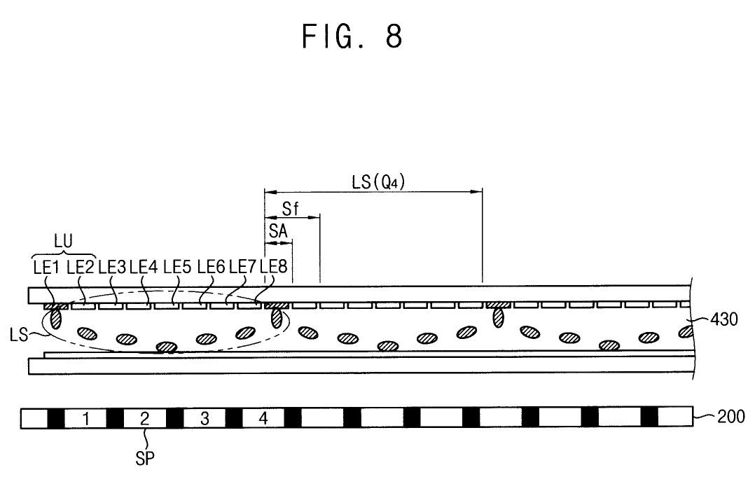

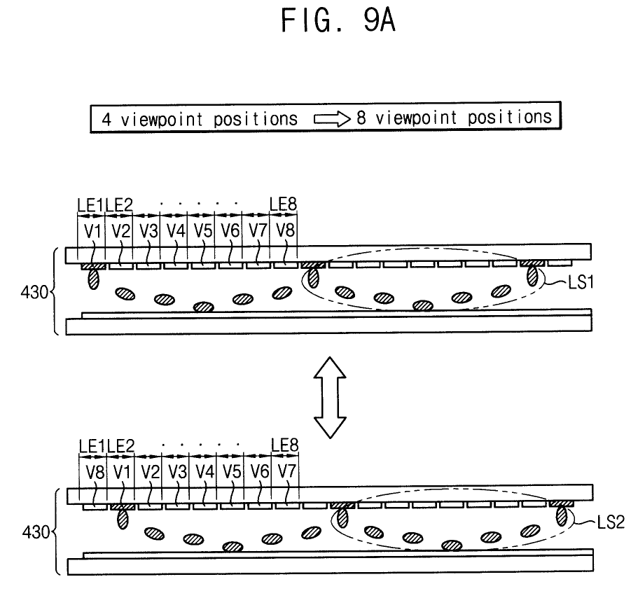

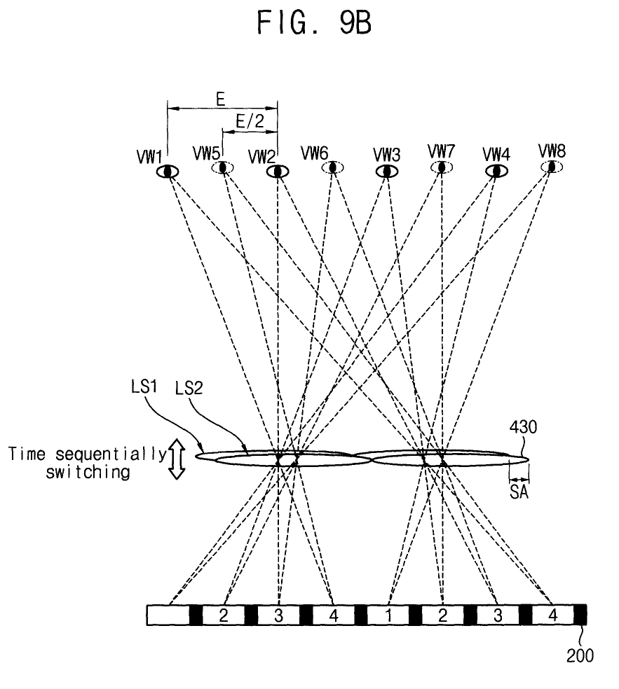

FIG. 8 is a cross-sectional view illustrating a liquid crystal lens panel 430 according to still another exemplary embodiment of the present invention. FIGS. 9A and 9B are cross-sectional views illustrating multi-viewpoint driving of the liquid crystal lens panel 430 of FIG. 8.

Referring to FIG. 8, the liquid crystal lens panel 430 includes a plurality of lens structures LS for four viewpoints. Each lens structure LS includes four lens units LU. Each lens unit LU includes two lens electrodes, for example, lens electrodes LE1, LE2 are included in one of the lens units LU. Accordingly, the lens structure LS may include eight lens electrodes LE1, LE2, LE3, LE4, LE5, LE6, LE7, LE8. A unit area Sf includes two sub-areas (i.e., 2×SA) corresponding to the number of lens electrodes included in the lens unit LU. The length Q4 of the lens structure LS for four viewpoints is 4 times the length of the unit area Sf. The display panel 200 corresponding to the liquid crystal lens panel 430 alternately displays four viewpoint images 1, 2, 3, 4 on every four consecutive subpixels.

In a multi-viewpoint mode, the method of driving the liquid crystal lens panel 430 is performed as follows. Referring to FIGS. 1, 9A, and 9B, the conversion driver 500 applies driving voltages V1, V2, V3, V4, V5, V6, V7, V8 to lens electrodes LE1, LE2, LE3, LE4, LE5, LE6, LE7, LE8 lens structure, respectively, during a first interval of a frame.

Accordingly, the liquid crystal lens panel 430 operates as a first lens structure LS1 to emit four viewpoint images displayed on the display panel 200, to viewpoint positions VW1, VW2, VW3, VW4, during the first interval of the frame. Then, the conversion driver 500 applies shifted voltages (e.g., driving voltages V8, V1, V2, V3, V4, V5, V6, V7) to lens electrodes LE1, LE2, LE3, LE4, LE5, LE6, LE7, LE8, respectively, during a second interval of the frame.

Accordingly, the liquid crystal lens panel 430 operates as a second lens structure LS2, which is moved by on sub-area SA, i.e., by a width of one lens electrode, with respect to the first lens structure LS1, to emit four viewpoint images displayed on the display panel 200, to fifth, sixth, seventh, and eighth viewpoint positions VW5, VW6, VW7, VW8, during the second interval of the frame. The liquid crystal lens panel 430 may sequentially operate as the first and the second lens structures LS1, LS2 during a frame, to emit the eight viewpoint images during the frame.

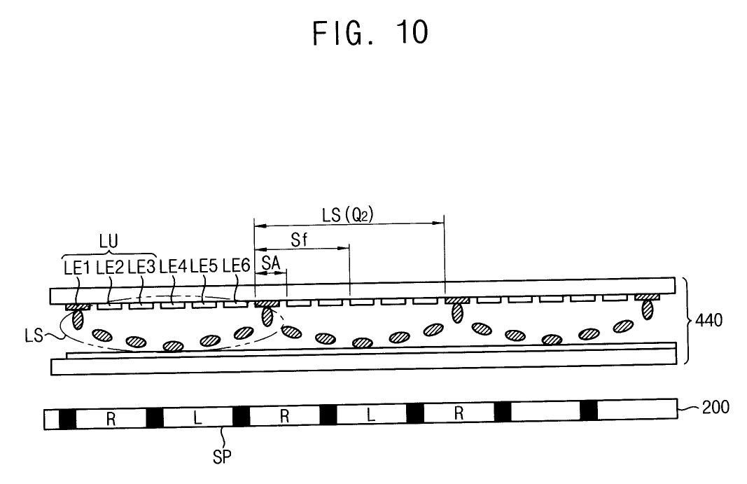

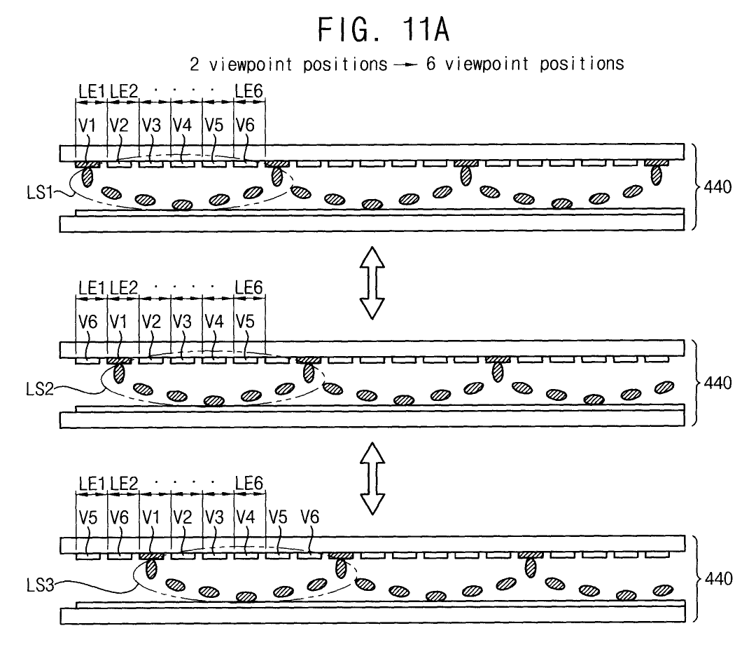

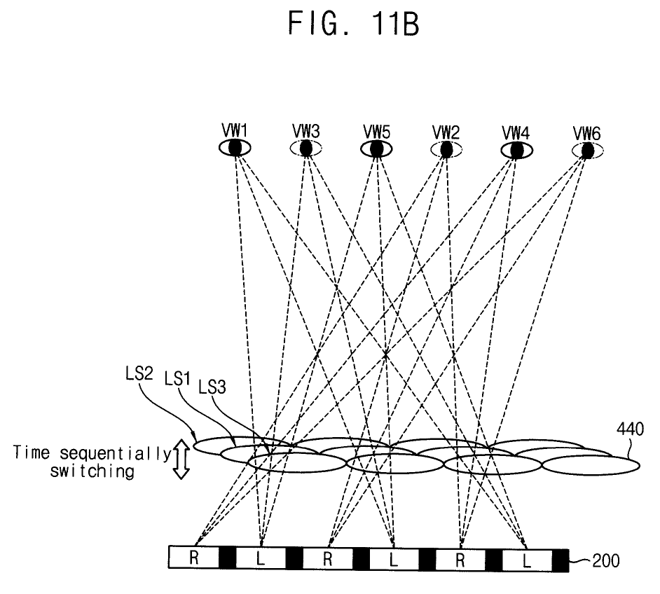

FIG. 10 is a cross-sectional view illustrating a liquid crystal lens panel 440 according to still another exemplary embodiment of the present invention. FIGS. 11A and 11B are cross-sectional views illustrating multi-viewpoint driving of the liquid crystal lens panel 440 of FIG. 10.

Referring to FIG. 10, the liquid crystal lens panel 440 includes a plurality of lens structures LS to display two viewpoints. Each lens structure LS includes two lens units LU. A lens unit LU may correspond to an emission area as described above. Each lens unit LU includes three lens electrodes LE1, LE2, LE3. Accordingly, the lens structure LS may include six lens electrodes LE1, LE2, LE3, LE4, LE5, LE6. A unit area Sf has a length approximately three times the length of the sub-area SA of a lens electrode, i.e., corresponds includes three sub-areas (i.e., 3×SA) corresponding to the number of lens electrodes included in the lens unit LU. The length Q2 of the lens structure LS is twice the length of the unit area Sf.

The display panel 200 corresponding to the liquid crystal lens panel 440 for two viewpoints alternately displays two viewpoint images L, R on every consecutive two subpixels.

In a multi-viewpoint mode, the method of driving the liquid crystal lens panel is performed as follows. Referring to FIGS. 1, 11A, and 11B, the conversion driver 500 is applies driving voltages V1, V2, V3, V4, V5, V6 to lens electrodes LE1, LE2, LE3, LE4, LE5, LE6 included in each lens structure Ls, respectively, during a first interval of a frame. Accordingly, the liquid crystal lens panel 430 operates as a first lens structure LS1 to emit two viewpoint images displayed on the display panel 200 to viewpoint positions VW1, VW2, during the first interval of the frame.

Then, the conversion driver 500 applies shifted voltages (e.g., driving voltages V6, V1, V2, V3, V4, V5) to lens electrodes LE1, LE2, LE3, LE4, LE5, LE6, respectively, during a second interval of the frame. Accordingly, the liquid crystal lens panel operates as a second lens structure LS2, which is moved by a width of one lens electrode with respect to the first lens structure LS1, to emit two viewpoint images displayed on the display panel 200 to viewpoint positions VW3, VW4, during the second interval of the frame.

Then, the conversion driver 500 applies shifted voltages (e.g., driving voltages V5, V6, V1, V2, V3, V4) to the lens electrodes LE1, LE2, LE3, LE4, LE5, LE6, respectively, during a third interval of the frame.

Accordingly, the liquid crystal lens panel 440 operates as a third lens structure LS3, which is moved by a width of one lens electrode with respect to the second lens structure LS2, to emit two viewpoint images displayed on the display panel 200 to a fifth and a sixth viewpoint positions VW5, VW6, during the third interval of the frame. The liquid crystal lens panel 440 may sequentially operate as the first, the second, and the third lens structures LS1, LS2, LS3, during a frame, to emit the total of six viewpoint images during the frame.

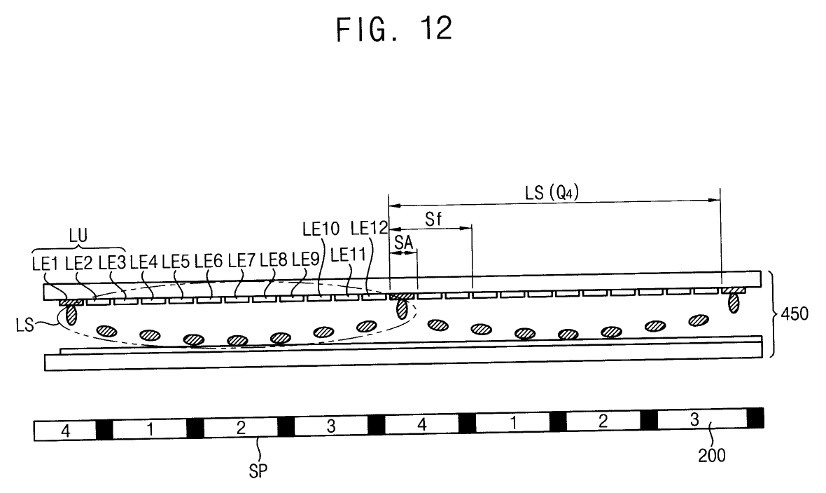

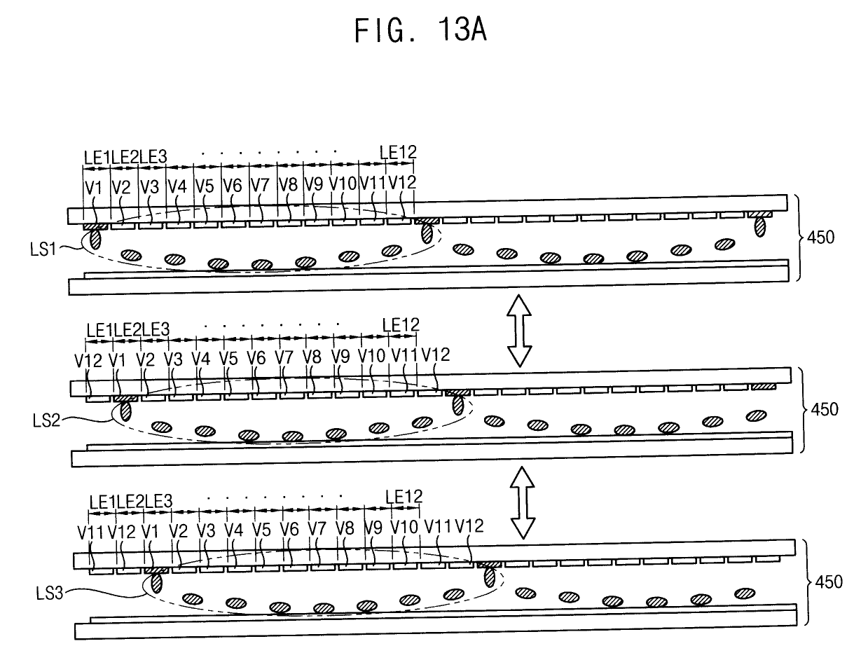

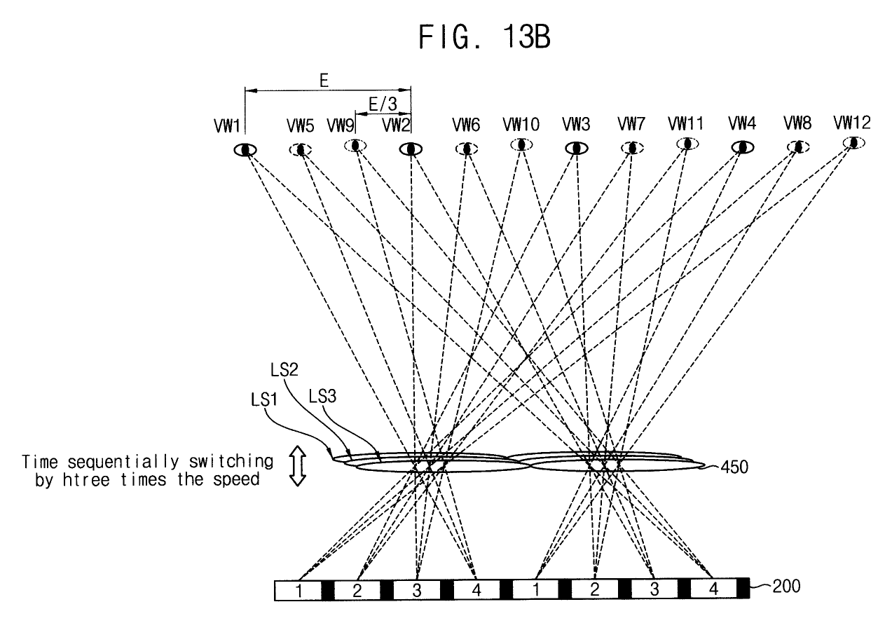

FIG. 12 is a cross-sectional view illustrating a liquid crystal lens panel 450 according to still another exemplary embodiment of the present invention. FIGS. 13A and 13B are cross-sectional views illustrating multi-viewpoint driving of the liquid crystal lens panel 450 is of FIG. 10.

Referring to FIG. 12, the liquid crystal lens panel 450 includes a plurality of lens structures LS. Each lens structure LS includes four lens units LU. Each lens unit LU includes three lens electrodes. For example, lens electrodes LE1, LE2, LE3 may be included in a first lens unit LU. Accordingly, the lens structure LS may include twelve lens electrodes LE1, LE2, LE3, LE4, LE5, LE6, LE7, LE8, LE9, LE10, LE11, LE12. A unit area Sf includes three sub-areas SA and corresponds to the number of lens electrodes included in the lens unit LU. The length Q4 of the lens structure LS is 4 times that of the unit area Sf. The display panel 200 corresponding to the liquid crystal lens panel 450 alternately displays four viewpoint images 1, 2, 3, 4 on four consecutive subpixels in a row direction.

In a multi-viewpoint mode, the method of driving the liquid crystal lens panel 450 is performed as follows. Referring to FIGS. 1, 12A, 12B, the conversion driver 500 applies driving voltages V1, V2, V3, V4, V5, V6, V7, V8, V9, V10, V11, V12 to lens electrodes LE1, LE2, LE3, LE4, LE5, LE6, LE7, LE8, LE9, LE10, LE11, LE12 included in each lens structure LS, respectively, during a first interval of a frame.

Accordingly, the liquid crystal lens panel 450 operates as a first lens structure LS1 to emit four viewpoint images displayed on the display panel 200, to viewpoint positions VW1, VW2, VW3, VW4, during the first interval of the frame. Then, the conversion driver 500 applies shifted voltages (e.g., driving voltages V12, V1, V2, V3, V4, V5, V6, V7, V8, V9, V10, V11) to electrodes LE1, LE2, LE3, LE4, LE5, LE6, LE7, LE8, LE9, LE10, LE11, LE12, respectively, during a second interval of the frame.

Accordingly, the liquid crystal lens panel 450 operates as a second lens structure LS2, which is moved by a width of a sub-area SA corresponding to one lens electrode, with respect to the first lens structure LS1, to emit four viewpoint images displayed on the display panel 200 to viewpoint positions VW5, VW6, VW7, VW8, during the second interval of the frame. Then, the conversion driver 500 applies shifted voltages (e.g., driving voltages V11, V12, V1, V2, V3, V4, V5, V6, V7, V8, V9, V10) to electrodes LE1, LE2, LE3, LE4, LE5, LE6, LE7, LE8, LE9, LE10, LE11, LE12, respectively, during a third interval of the frame.

Accordingly, the liquid crystal lens panel 450 operates as a third lens structure LS3, which is moved by a width SA of one lens electrode, with respect to the second lens structure SA2, to emit four viewpoint images displayed on the display panel 200 to viewpoint positions VW9, VW10, VW11, VW12. The liquid crystal lens panel 450 may sequentially operate as lens structures LS1, LS2, LS3, during a frame, to emit the total of twelve viewpoint images during the frame.

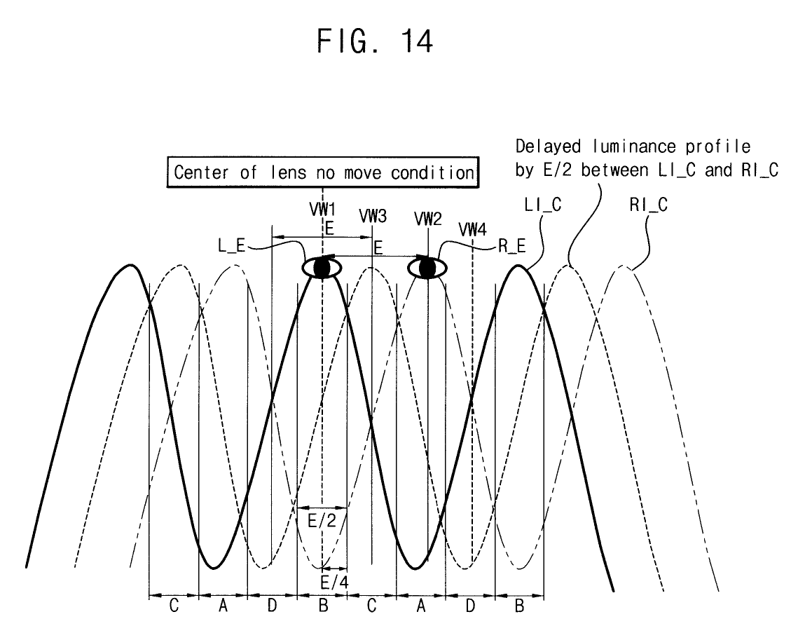

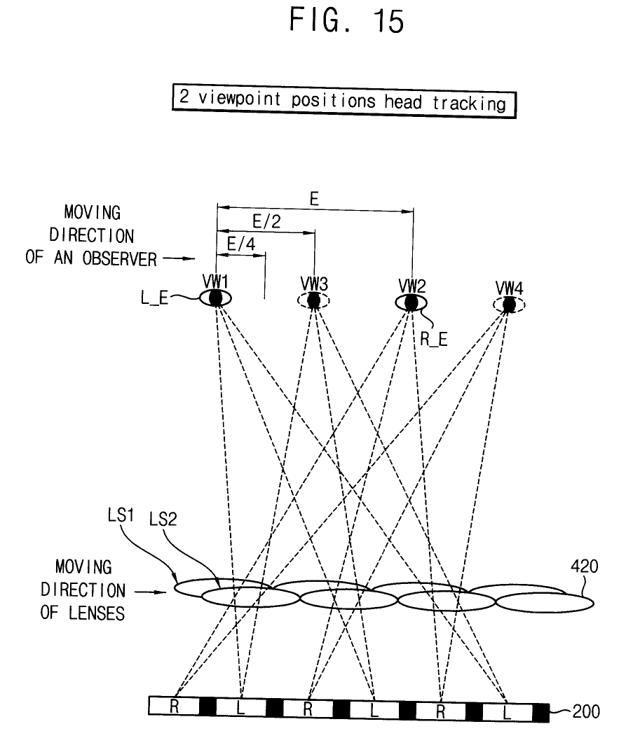

FIG. 14 is a luminance profile of three-dimensional stereoscopic images produced by the liquid crystal lens panel of FIG. 6. FIG. 15 is a cross-sectional view illustrating a tracking mode performed using the liquid crystal lens panel of FIG. 6, when an observer's position is within an observation distance.

Referring to FIG. 14, each of a luminance profile of a left-eye image LI_C and a luminance profile of a right-eye image RI_C each have a sinusoidal shape. The luminance profile of the left-eye image LI_C is delayed by an eye distance E measured between a left eye and a right eye of an observer, with respect to the luminance profile RI_C of the right-eye image.

If the left eye L_E of the observer is located at a position corresponding to a peak point of the luminance profile LI_C of the left-eye image, and the right eye R_E of the observer is located at a position corresponding to a peak point of the luminance profile RI_C of the right-eye image, then the observer may receive a stereoscopic image that does not include is crosstalk.

Referring to FIGS. 1, 14 and 15, in a tracking mode, if the observer's position is located within a set observation distance, the controller 100 analyzes how far the observer moves in a right-and-left direction. For example, if a left eye L_E or a right eye R_E of the observer moves by a distance E/2 of the eye distance E, the controller 100 controls driving voltages applied to the liquid crystal lens panel 420 to move the position of the lens structure LS by a corresponding amount.

Referring to FIGS. 6, 7A, and 7B, if the left eye L_E and the right eye R_E of the observer are located originally at a first and a second viewpoint positions VW1, VW2, driving voltages V1, V2, V3, V4 are respectively applied to lens electrodes LE1, LE2, LE3, LE4, to form a first lens structure LS1. Two viewpoint images (i.e., a left-eye image L and a right-eye image R) displayed on the display panel 200 are emitted to the first and the second viewpoint positions VW1, VW2, via the first lens structure LS1. Accordingly, the left eye L_E and the right eye R_E of the observer, which are respectively located at the first and the second viewpoint positions VW1, VW2, receive the left-eye image L and the right-eye image R, respectively.

Then, if the tracking part 900 determines that the observer's eyes move by E/2 in a left-to-right direction from the viewpoint positions VW1, VW2 to viewpoint positions VW3, VW4, the conversion driver 500 respectively applies driving voltages V4, V1, V2, V3 to the lens electrodes LE1, LE2, LE3, LE4, according to the control of the controller 100. Accordingly, a second lens structure LS2, which is moved by a width of one lens electrode in a left-to-right direction with respect to the first lens structure LS1, is formed. A left-eye image L and a right-eye image R, displayed on the display panel 200 are emitted to viewpoint positions VW3, VW4, via the second lens structure LS2. Accordingly, the left eye L_E and the right eye R_E of the observer, which are respectively disposed at viewpoint positions VW3, VW4, receive the left-eye image L and the right-eye image R, respectively.

Although not shown, if the observer's position moves by E/2 in a right-to-left direction, the observer may receive a left-eye image and a right-eye image at the new positions by forming a second lens structure LS2, which is moved by a width of one lens electrode in a right-to-left direction, with respect to the first lens structure LS1, in substantially the same way.

Again, referring to FIG. 14, if the observer's position moves more than E/4 in a right-and-left direction, the left eye L_E and the right eye R_E of the observer receive the luminance profiles corresponding to adjacent viewpoint positions. Accordingly, if the left eye or the right eye of the observer is beyond a distance of E/4 in a right-and-left direction, then the controller 100 controls the liquid crystal lens panel 420 to form a second lens structure LS2 lens structure, and the left eye L_E and the right eye R_E of the observer respectively receive a left-eye image L and a right-eye image R.

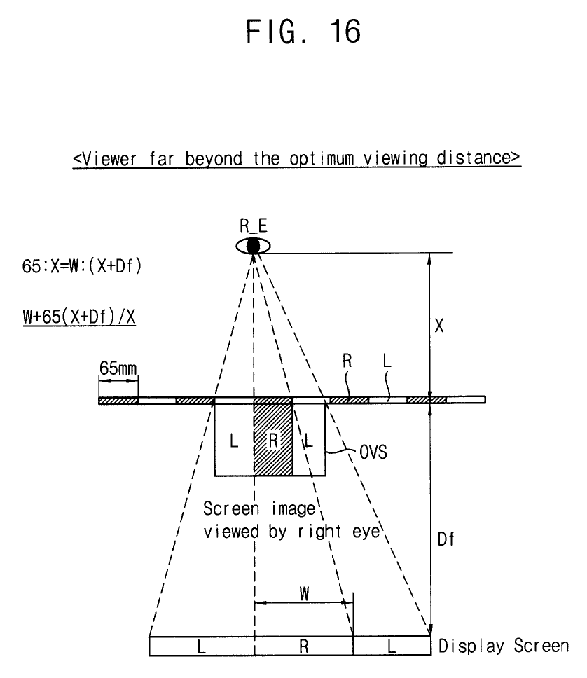

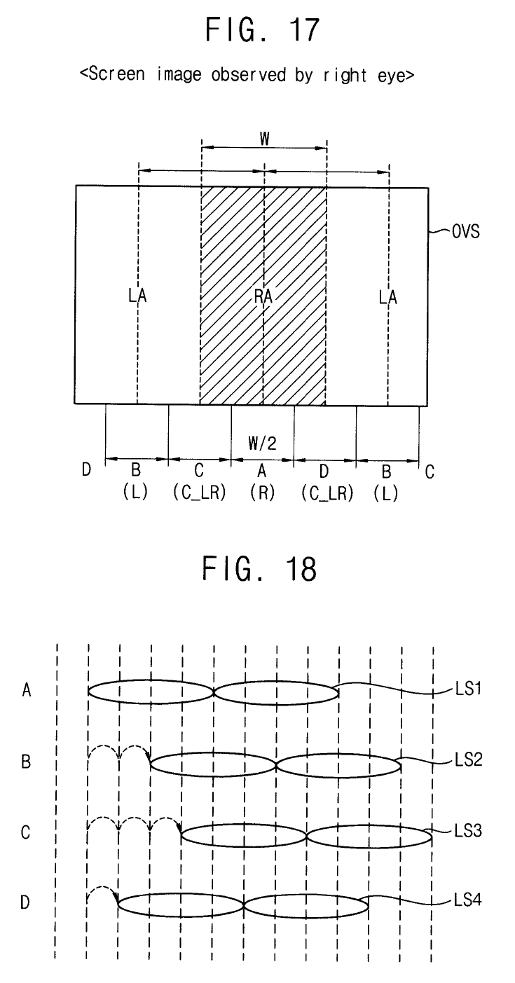

FIG. 16 is a cross-sectional view illustrating a tracking mode of the liquid crystal lens panel 420 of FIG. 6, when the observer's position is located beyond the observation distance. FIG. 17 is a plan view of an observer screen according to the tracking mode of FIG. 16. FIG. 18 is a timing chart illustrating the control of the position of a lens structure corresponding to the observer screen of FIG. 17.

Referring to FIG. 16, a lens structure or a lens electrode of the liquid crystal lens panel 420 has a striped structure as illustrated in FIG. 3A. If the observer's position is beyond an observation distance Df, then the left eye (or the right eye) of the observer may receive a left-eye image (or a right-eye image) and a boundary between the left-eye image and is the right-eye image. For example, an observer screen of the display apparatus observed from the right eye R_E of the observer at the observation distance Df is an right-eye image.

However, because a visual field is wide when the observer is located beyond the observation distance Df, the right eye R_E of the observer receives a left-eye image L as well as a right-eye image R. If the observer is located beyond the observation distance, the controller 100 computes an observer screen OVS to approximate a screen view at the observer's position, by executing an analyzing algorithm.

As illustrated in FIG. 17, the observer screen OVS received by the right eye R_E of the observer includes a left-eye image L and a right-eye image R. Each of the left-eye image L and the right-eye image R received at the right-eye R_E of the observer has a width W.

The controller 100 divides the observer screen OVS into a left-eye (or a right-eye) image area and mixed image area. The controller 100 determines a central part of the left-eye image LA (or a central part of the right-eye image RA) and a boundary part between the left-eye image area LA and the right-eye image area RA. And the controller 100 divides the area between the central part and the boundary part into M areas (e.g., into two areas). The controller 100 divides the observer screen OVS into a first area A, a second area B, a third area C, and a fourth area D.

The first area A is an area in which the right-eye image R is observed. The second area B is an area in which the left-eye image L is observed. The third area C is an area in which a first mixed image C_LR is observed at a position between the second area B and the first area A. The fourth area D is an area in which a second mixed image C_RL is observed at a position between the first area A and the second area B.

Each of the left-eye image L and the right-eye image R displayed on a is screen of the display apparatus may have substantially the same width W in principle. The position of a lens structure may be controlled differently in an area of every W/M (e.g., W/2 where M is two) from the boundary between the left-eye (or the right-eye) image area and the mixed area.

Thus, the controller 100 controls driving voltages applied to lens electrodes disposed in the liquid crystal lens panel, on the basis of the left-eye (or the right-eye) image and the mixed image received from each area A, B, C, D, to control the position of a lens structure. The right eye R_E of the observer may receive a right-eye image displayed on areas A, B, C, D, according to a movement of the lens structure.

For example, referring to FIG. 14 and FIG. 18, the first area A is an area which the right eye of the observer receives the right-eye image R. A first lens structure LS1 of the first area A of the liquid crystal lens panel is regarded as a standard position, hereinafter.

The second area B is an area which the right eye R_E of the observer receives a left-eye image L. The second area B arrives at a peak point of the profile RI_C of the right-eye image, when the right eye R_E moves by twice E/2 in a left-to-right direction, to receive the right-eye image R. Accordingly, a second stereoscopic lens LS2 of the second area B moves by a distance of twice the width of a lens electrode, in a left-to-right direction with respect to the first lens structure LS1. The second area B of the liquid crystal lens panel may operate as the second lens structure LS2, for the right eye R_E of the observer to receive the right-eye image R in the second area B.

The third area C is an area which the right eye R_E of the observer receives the first mixed image C_LR. The third area C arrives at a peak point of the profile of the right-eye image RI_C, when the right eye R_E moves by 3 times E/2, in a left-to-right direction to is receive the right-eye image R. Accordingly, a third lens structure LS3 of the third area C moves by a distance of three times the width of a lens electrodes, with respect to the first lens structure LS1. The third area C of the liquid crystal lens panel may operate as the third lens structure LS3 for the right eye R_E of the observer to receive the right-eye image R in the third area C.

The fourth area D is an area which the right eye R_E of the observer receives the second mixed image C_RL. The third area C arrives at a peak point of the profile of the right-eye image RI_C, when the right eye R_E moves by E/2 in a left-to-right direction, to receive the right-eye image R. Accordingly, a fourth lens structure LS4 of the fourth area D moves by a width of one lens electrode, with respect to the first lens structure LS1 of the first area A. The fourth area D of the liquid crystal lens panel may operate as the fourth lens structure LS4, for the right eye R_E of the observer to receive the right-eye image R in the fourth area D.

As mentioned above, the left eye or the right eye of the observer located beyond the observation distance may respectively receive a corresponding left-eye image or a corresponding right-eye image by controlling the position of the lens structure of the liquid crystal lens panel.

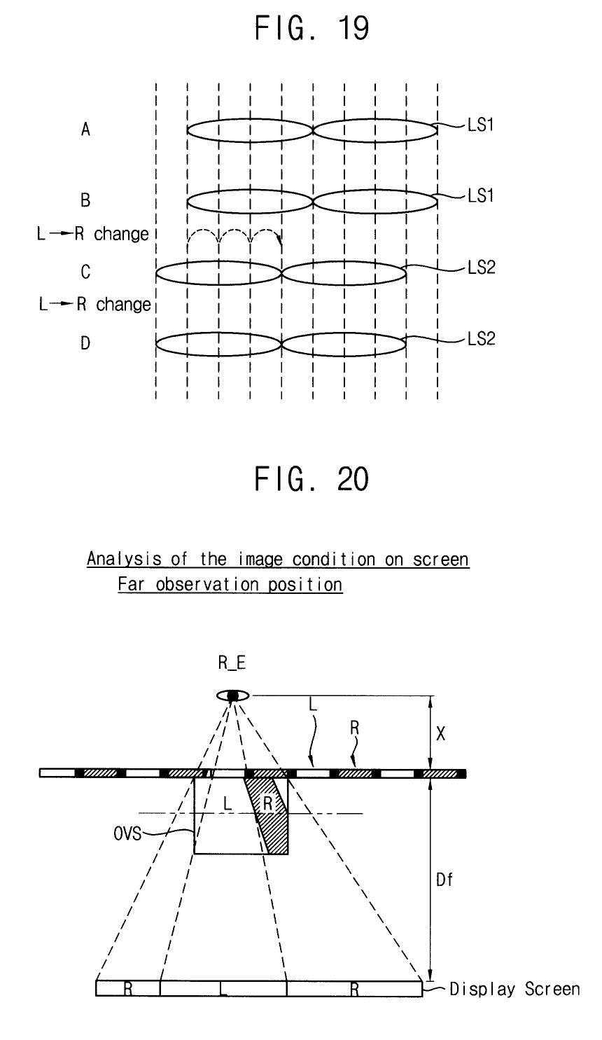

FIG. 19 is a timing chart illustrating the control of the position of a lens structure corresponding to an observer screen, according to another exemplary embodiment of the present invention. Referring to FIG. 19, the lens structure or the lens electrode of the liquid crystal lens panel has a striped structure as illustrated in FIG. 3.

The controller 100 controls a left-eye image (or a right-eye image) displayed on the display panel and the position of the lens structure, on the basis of a left-eye image (or a right-eye image) and a mixed image received at each of areas A, B, C, D.

For example, the first area A and the second area B are different viewpoint is areas from which the right eye R_E of the observer receives a right-eye image R and a left-eye image L, respectively. The third area C and the fourth area D area are mixed areas from which the right eye R_E of the observer receives a first mixed image C_LR and a second mixed image C_RL, respectively.

Referring to FIGS. 14, 17, and 19, the first area A and the second area B are areas which the right eye R_E of the observer receives the right-eye image R and the left-eye image L. The controller 100 sets a first lens structure LS1 of the first area A and the second area B as a standard position. By this, the right eye R_E of the observer receives the right-eye image R via the first lens structure LS1 in the first area A.

In contrast, in the second area B, the right eye R_E of the observer receives the left-eye image L via the first lens structure LS1. Accordingly, the controller 100 renders image data to display the right-eye image R on the portion of the display panel corresponding to the second area B. As a result, the right eye R_E of the observer may receive the right-eye image R via the first lens structure LS1, by displaying the right-eye image R on an area of the display panel corresponding to the second area B.

The third area C and the fourth area D are areas in which the right eye R_E of the observer receives the first and the second mixed images C_LR, C_RL, respectively. The controller 100 moves a second lens structure LS2 of the third area C and the fourth area D, with respect to the position of the first lens structure LS1.

For example, if the second lens structure LS2 moves by a width of three lens electrodes with respect to the first lens structure LS1, the first mixed image C_LR displayed on the third area C is observed as the left-eye image L that is moved by 3 times E/2 in a left-to-right direction, by the second lens structure LS2. The controller 100 renders image data to display the is right-eye image R on an area of the display panel corresponding to the third area C. Accordingly, the right eye R_E of the observer may receive the right-eye image R in the third area C.

If the second lens structure LS2 moves by three lens electrodes in a right-to-left direction, with respect to the first lens structure LS1, the second mixed image C_RL displayed on the fourth area D is observed as the right-eye image R, which is moved by 3 times E/2 in a left-to-right direction by the second lens structure LS2. Accordingly, the right eye R_E of the observer may receive the right-eye image R in the fourth area D.

According to the present exemplary embodiment, eyes (a left eye or a right eye) of the observer may receive corresponding viewpoint images by controlling the position of the lens structure according to the different viewpoint area and the mixed area, and by controlling image data on the basis of the two types of lens structure.

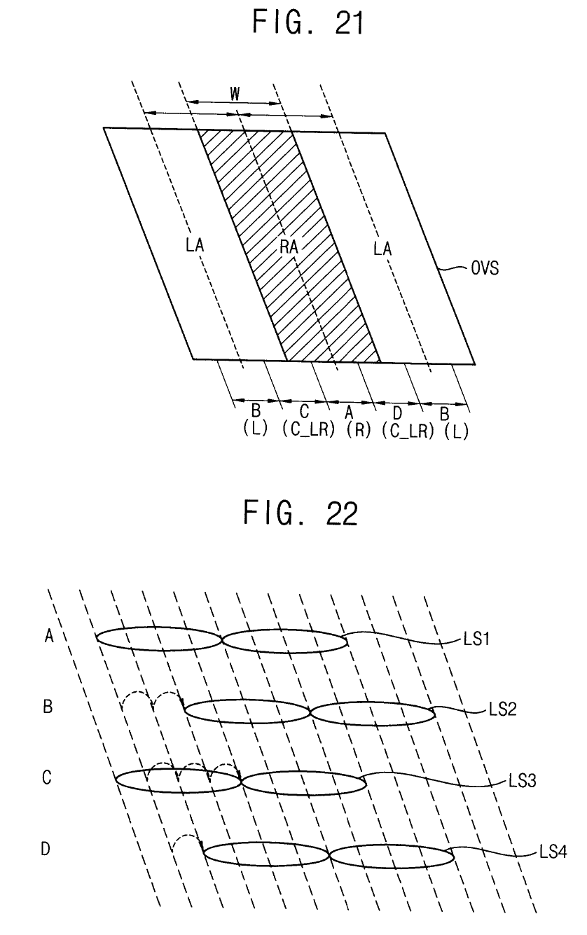

FIG. 20 is a cross-sectional view illustrating a tracking mode of a liquid crystal lens panel according to still another exemplary embodiment of the present invention, when the observer's position is located beyond the observation distance. FIG. 21 is a plan view of the observer screen according to the tracking mode of FIG. 20. FIG. 22 is a timing chart illustrating the control of the position of a lens structure corresponding to the observer screen of FIG. 20.

Referring to FIGS. 20 and 21, the liquid crystal lens panel 420 according to the present exemplary embodiment includes a lens structure including four lens electrodes LE1, LE2, LE3, LE4, as illustrated in FIG. 6. The lens structure or the lens electrode have a tilted structure as illustrated in FIG. 3B.

If the observer is located beyond the observation distance Df, then the left eye and the right eye of the observer receive a left-eye image, a right-eye image, and a boundary between the left-eye image and the right-eye image. The tilted direction of the boundary is substantially the same as the tilted direction of the lens structures or the lens electrodes.

According to the present exemplary embodiment, the control of the position of the lens structures may be performed in substantially the same way as illustrated in FIG. 18, according to an observer screen.

The controller 100 analyzes the observer screen on the basis of the tracked observer's position. The observer screen OVS includes a left-eye image area LA and a right-eye image area RA. The observer screen OVS includes a first area A, a second area B, a third area C, and a fourth area D.

The first area A is an area in which a right-eye image R is observed. The second area B is an area in which a left-eye image L is observed. The third area C is an area in which a first mixed image C_LR is observed and is located between the second area B and the first area A. The fourth area D is an area in which a second mixed image C_RL is observed and is located between the first area A and the second area B.

Thus, the controller 100 controls driving voltages applied to the lens electrodes disposed in the liquid crystal lens panel 420, on the basis of viewpoint images and mixed images received at each of areas A, B, C, D, to control the position of the lens structure.

Referring to FIGS. 14 and 22, a first lens structure LS1 of the first area A, in which the right-eye image R is observed, is regarded as a standard position, hereinafter. A second lens structure LS2 of the second area B on which the left-eye image L is observed is moved by a distance corresponding to the width of two lens electrodes, in a left-to-right direction with respect to the first lens structure LS1 of the first area A, for the right-eye image R to be observed.

A third lens structure LS3 of the third area C, in which the first mixed image C_LR is observed, is moved by a distance of three lens electrode widths, in a left-to-right direction with respect to the first lens structure LS1 of the first area A, for the right-eye image R to be observed. A fourth lens structure LS4 of the fourth area D, in which the second mixed image C_RL is observed, is moved by a distance corresponding to one lens electrode width, in a left-to-right direction with respect to the first lens structure LS1 of the first area A, for the right-eye image R to be observed.

As mentioned above, the left eye or the right eye of the observer located beyond the observation distance may respectively receive a corresponding left-eye image or a corresponding right-eye image, by controlling the position of the lens structure of the liquid crystal lens panel.

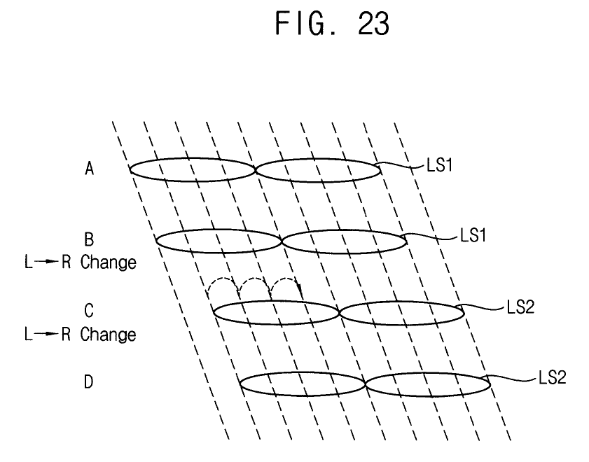

FIG. 23 is a timing chart illustrating the control of the position of a lens structure corresponding to an observer screen, according to still another exemplary embodiment of the present invention. Referring to FIGS. 1 and 23, the liquid crystal lens panel 420 includes the lens structure including four lens electrodes LE1, LE2, LE3, LE4 illustrated in FIG. 6. The lens structure or the lens electrodes have a tilted structure as illustrated in FIG. 3B.

The controller 100 controls the position of the lens structure and viewpoint images displayed on the display panel, on the basis of viewpoint images and mixed images received at each of the first, the second, the third, and the fourth areas A, B, C, D. The control of the display image and the position of the lens may be performed in substantially the same way illustrated in FIG. 19, in accordance with an observer screen.

A first lens structure LS1 of the first area A and the second area B is regarded as a standard position. In the first area A, a right-eye image R is observed by the first is lens structure LS1. Because a left-eye image L is observed in the second area B through the first lens structure LS1, image data is rendered for the right-eye image R to be displayed on the display panel corresponding to the second area B.

A second lens structure LS2 of the third area C and the fourth area D is moved by a distance corresponding to the widths of three lens electrodes, in a left-to-right direction from the first lens structure LS1. Because the left-eye image L is observed in the third area C, on which the first mixed image C_LR is observed by the second lens structure LS2, the image data is rendered for the right-eye image R to be displayed on the portion of the display panel corresponding to the third area C. In the fourth area D, on which the second mixed image C_RL is observed, the right-eye image R is observed through the second lens structure LS2.

According to the present exemplary embodiment, eyes of the observer may receive corresponding viewpoint images by controlling the position of the lens structure according to different viewpoint areas and mixed areas and by controlling image data on the basis of the two lens structures.

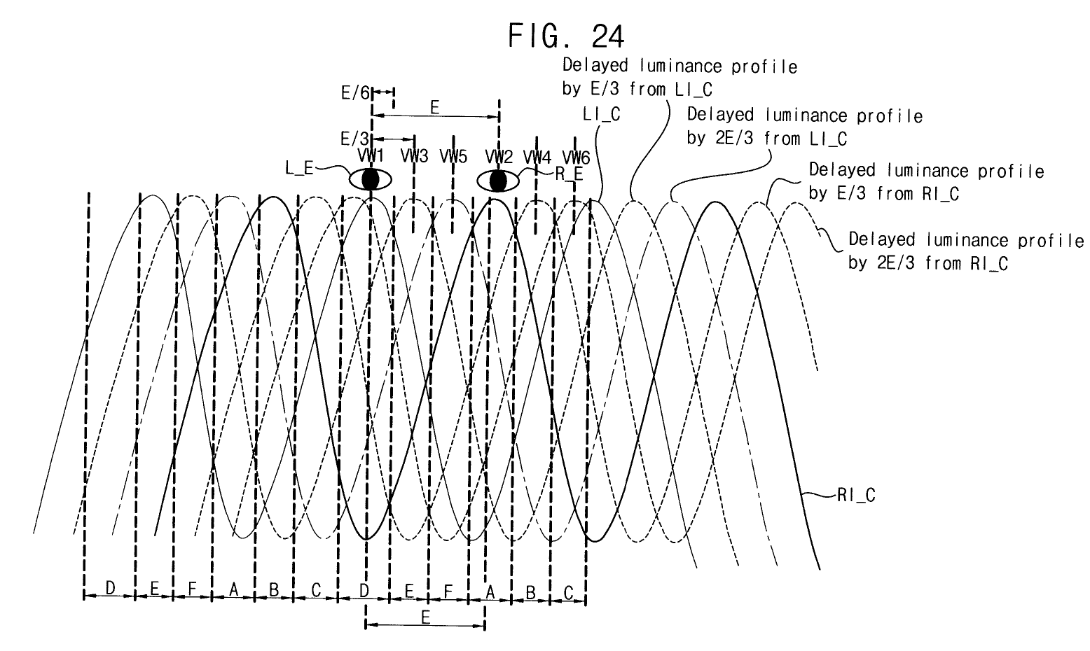

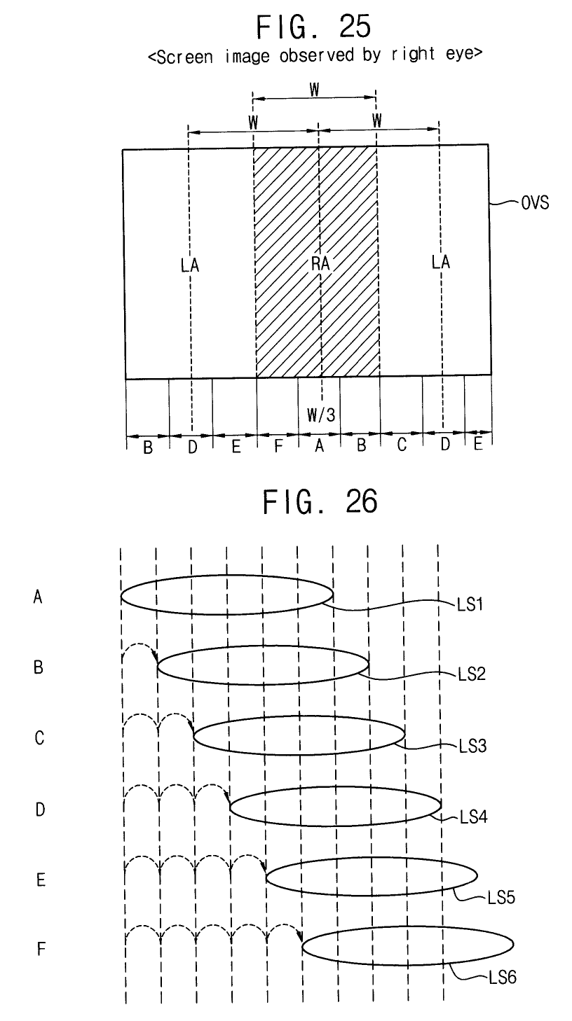

FIG. 24 is a luminance profile of three-dimensional stereoscopic images according to the liquid crystal lens panel 440 of FIG. 10. FIG. 25 is a plan view of the observer screen according to the liquid crystal lens panel 440 of FIG. 10. FIG. 26 is a timing chart illustrating the control of the position of a lens structure corresponding to the observer screen of FIG. 25.

Referring to FIGS. 10 and 24, the lens unit LU of the liquid crystal lens panel 440 includes first, second, and third lens electrodes LE1, LE2, LE3. And a lens structure LS includes first, second, third, fourth, fifth, and sixth lens electrodes LE1, LE2, LE3, LE4, LE5, LE6. The lens unit LU includes three of the lens electrodes.

Each of the luminance profile LI_C of a left-eye image and the luminance profile RI_C of the right-eye image, which are two viewpoint images, have sinusoidal shapes. The luminance profile LI_C of the left-eye image delays by an eye distance E of a left eye LE and a right eye RE of the observer with respect to the luminance profile RI_C of the right-eye image.

If the left eye L_E of the observer is located at a position corresponding to a peak point of the luminance profile LI_C of the left-eye image, and if the right eye R_E of the observer is located at a position corresponding to a peak point of the luminance profile RI_C of the right-eye image, the observer may receive a normal stereoscopic image without crosstalk.

The controller 100 computes an observer screen OVS including a left-eye image L and a right-eye image R observed by the right-eye R_E of the observer. Alternatively, the controller 100 divides the observer screen OVS into a left-eye (or a right-eye) image area and a mixed image area. For example, the controller 100 determines a central part of the left-eye image LA (or a central part of the right-eye image RA) and a boundary part between the left-eye image area LA and the right-eye image area RA. The controller 100 divides the area between the central part and the boundary part into M areas (e.g., into three areas). As a result, the controller 100 divides the observer screen OVS into a first area A, a second area B, a third area C, a fourth area D, a fifth area E, and a sixth area F.

Each area of the left-eye image L and the right-eye image R, which are displayed on a screen of the display apparatus, may have substantially the same width W. The controller 100 may control the position of a stereoscopic lens differently in an area of every W/3 from the boundary of the left-eye (or the right-eye) image area and the mixed image area.

For example, referring to FIGS. 24, 25, and 26, a first lens LS1 formed in is the first area A, which the right eye of the observer receives a right-eye image R, is regarded as a standard position. The first area A of the liquid crystal lens panel 440 operates as the first lens structure LS1. Accordingly, the right eye R_E of the observer receives the right-eye image R from the first area A.

The second area B is an area which the right eye R_E of the observer receives a first mixed image C_RL1. A peak point of the luminance profile RI_C of the right-eye image occurs in the second area B when moved by E/3 in a left-to-right direction, to receive the right-eye image R. Accordingly, a second lens structure LS2 of the second area B moves by the width of one lens electrode, in a left-to-right direction with respect to the first lens structure LS1. The second area B of the liquid crystal lens panel 440 operates as the second lens structure LS2 for the right eye R_E of the observer, to receive the right-eye image R in the second area B.

The third area C is an area from which the right eye R_E of the observer receives a second mixed image C_RL2. The third area C arrives at a peak point of the luminance profile RI_C of the right-eye image when moved by 2 times E/3, in a left-to-right direction, to receive the right-eye image R. Accordingly, a third lens structure LS3 of the third area C moves by two lens electrode widths, in a left-to-right direction, with respect to the first lens structure LS1. The third area C of the liquid crystal lens panel 440 operates as the third lens structure LS3 for the right eye R_E of the observer to receive the right-eye image R in the third area C.

The fourth area D is an area which the right eye R_E of the observer receives a left-eye image L. The fourth area D arrives at a peak point of the luminance profile RI_C of the right-eye image when moved by 3 times E/3 in a left-to-right direction, to receive the right-eye image R. Accordingly, a fourth lens structure LS4 of the fourth area D moves by a width of three lens electrodes in a left-to-right direction, with respect to the first lens structure LS1. The fourth area D of the liquid crystal lens panel 440 operates as the fourth lens structure LS4 for the right eye R_E of the observer to receive the right-eye image R in the fourth area D.

The fifth area E is an area which the right eye R_E of the observer receives a third mixed image C_LR1. The fifth area E arrives at a peak point of the luminance profile RI_C of the right-eye image, when moved by 4 times E/3 in a left-to-right direction, to receive the right-eye image R. Accordingly, a fifth lens structure LS5 of the fifth area E moves by four lens electrode widths, in a left-to-right direction, with respect to the first lens structure LS1. The fifth area E of the liquid crystal lens panel 440 operates as the fifth lens structure LS5 for the right eye R_E of the observer to receive the right-eye image R in the fifth area E.

The sixth area F is an area which the right eye R_E of the observer receives a fourth mixed image C_LR2. The sixth area F arrives at a peak point of the luminance profile RI_C of the right-eye image when moved by 5 times E/3 in a left-to-right direction to receive the right-eye image R. Accordingly, a sixth lens structure LS6 of the sixth area F moves by a width of five lens electrodes in a left-to-right direction with respect to the first lens structure LS1. The sixth area F of the liquid crystal lens panel 440 operates as the sixth lens structure LS6 for the right eye R_E of the observer to receive the right-eye image R in the sixth area F.

As mentioned above, the left eye L_E or the right eye R_E of the observer located beyond the observation distance may respectively receive the left-eye image L or the right-eye image R, by controlling the position of the lens structure of the liquid crystal lens panel.

According to the liquid crystal lens panels illustrated in above exemplary embodiments, if the left eye or the right eye of the observer is located at a peak of the luminance profile in the observation distance of the luminance profile, the position of a lens structure is is moved by a width of at least one lens electrode, in a direction corresponding to a moving direction of the observer, when the observer moves more than ±E/(2M) in a right-and-left direction at the peak, under a condition that the lens structure has a length of 2M times N where M is the number of sub-areas included in a lens unit and N is the number of viewpoints. That is, M is the number of lens electrodes included in a lens unit LU having a width equal to that of lens area Sf. In addition, if a head of the observer moves by E/M in a right-and-left direction from a standard position, the position of the lens structure moves by a width of one lens electrode.

Each of a left-eye image and a right-eye image included in an observer screen which the observer located beyond an observation distance observes may have substantially the same width W. The position of the lens structure may be controlled differently in an area of every W/M from the boundary between the left-eye image area and the right-eye image area, where M is the number of sub-areas included in a lens unit.

If the lens structure has a length of 2 times M corresponding to two subpixels, then the observer may receive the left-eye image or the right-eye image in all area of the observer screen by controlling the position of 2×M types of lens structures.

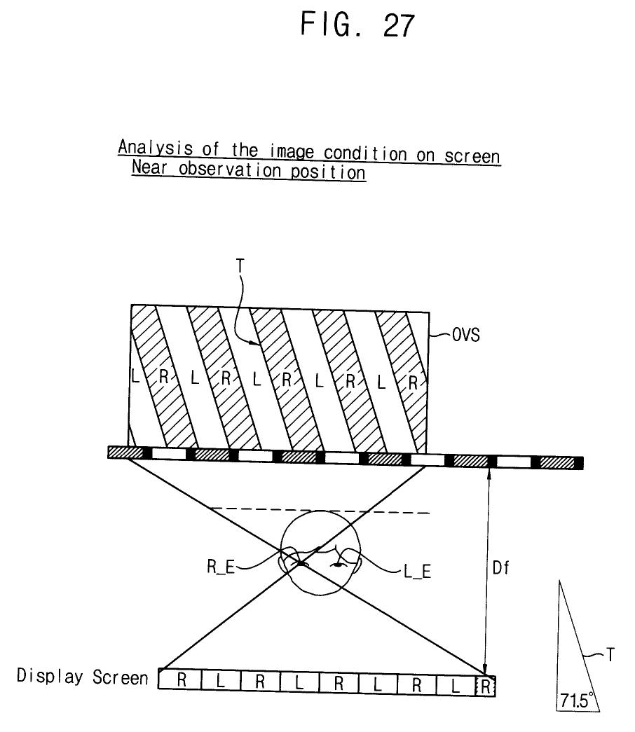

FIG. 27 is a cross-sectional view illustrating a tracking mode of a liquid crystal lens panel according to still another exemplary embodiment of the present invention when an observer's position is located in an observation distance.

Referring to FIG. 27, the lens structure (or the lens electrode) of the liquid crystal lens panel according to the present exemplary embodiment has a tilted structure as illustrated in FIG. 3B.

If the observer is located closer than the observation distance Df, then the observer receives an observer screen OVS. The observer screen OVS includes a left-eye image L, a right-eye image R, and a boundary B of the left-eye image and the right-eye image. The tilted direction T of the boundary B may be substantially the same as the tilted direction T of the lens structure (or the lens electrode) of the liquid crystal lens panel.

Thus, as illustrated in FIGS. 21 and 22, the timing controller 100 analyze the observer screen OVS to divide the observer screen OVS into a first area A in which the right-eye image R is observed, a second area B in which the left-eye image L is observed, a third area C in which a first mixed image C_LR is observed, and a fourth area D in which a second mixed image C_RL is observed. The controller 100 controls the position of lens structures disposed in each of the first to fourth area A, B, C, D. Accordingly, if the observer is located closer than the observation distance, one of the eyes of the observer may receive a corresponding viewpoint image.

Alternatively, as illustrated in FIGS. 21 and 23, the controller 100 may control the positions of lens structures into two types according to a different viewpoint area and a mixed area, and the eyes of the observer may receive corresponding viewpoint images by controlling image data on the basis of the two types of lens structures.

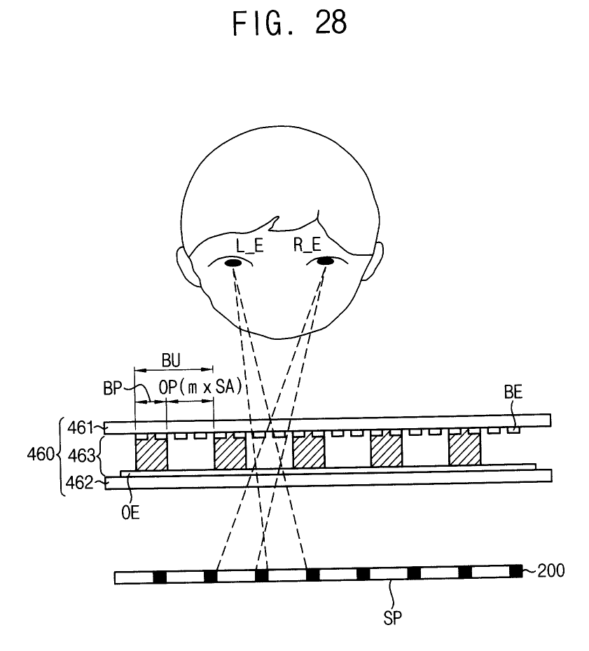

FIG. 28 is a cross-sectional view of a dynamic conversion panel of liquid crystal barrier type according to still another exemplary embodiment of the present invention. Referring to FIG. 28, the liquid crystal barrier panel 460 according to the present exemplary embodiment includes a first substrate 461, a second substrate 462, and a liquid crystal layer.

The first substrate 461 includes a plurality of barrier electrodes BE to form a barrier unit BU. The second substrate 462 includes a counter electrode facing the barrier electrode BE. The liquid crystal layer 463 forms the barrier unit BU which includes an opening OP that transmits light and a barrier BP that blocks light in response to a voltage applied to the barrier electrode BE and the counter electrode OE. The opening OP includes M sub-areas (M times SA), and corresponds to the barrier emission unit illustrated above. Referring to FIG. 2, the unit area Sf corresponds to one dot DT. The unit area Sf may be determined by a pitch p of the dots DT, a distance between the dots DT and the barrier unit BU, and an observation distance Df from the barrier unit BU designed.

Although the first substrate 461 is disposed in upper part and the second substrate 462 is disposed in lower part in FIG. 28, the positions in which the first and the second substrates 461, 462 are disposed are not limited thereto.

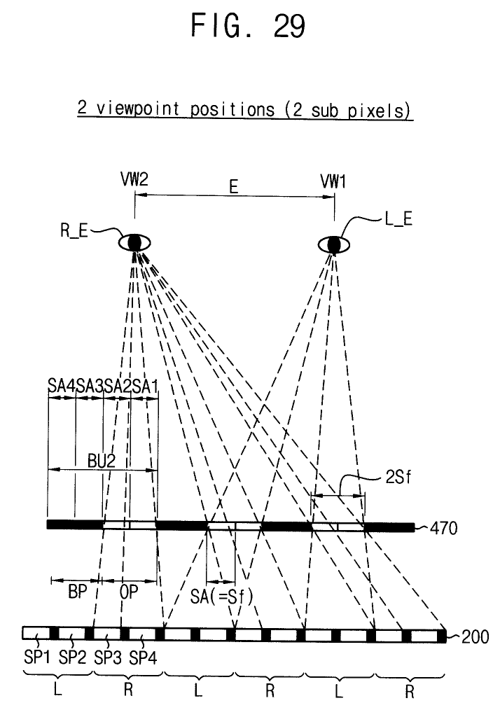

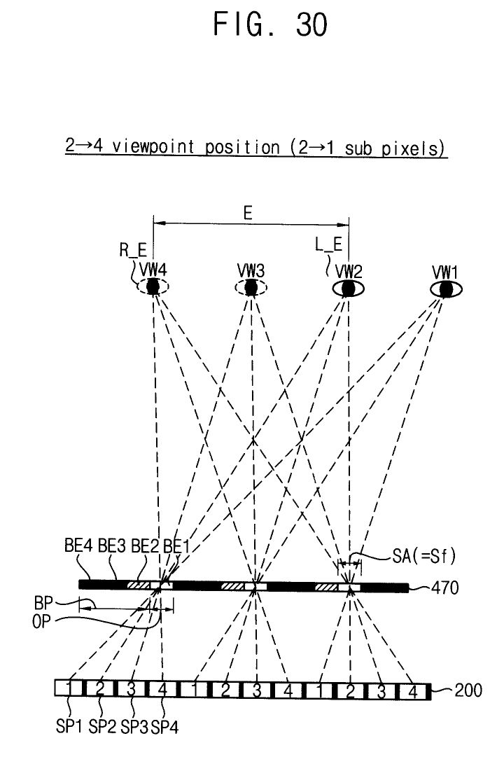

FIG. 29 is a cross-sectional view of a liquid crystal barrier panel 470 according to still another exemplary embodiment of the present invention. FIG. 30 is a cross-sectional view illustrating multi-viewpoint driving of the liquid crystal barrier panel of FIG. 29.

Referring to FIG. 29, the liquid crystal barrier panel 470 defines a barrier unit BU for two viewpoints corresponding to four sub-areas. The barrier unit BU includes an opening OP and a barrier BP. The opening OP is formed on sub-areas SA1, SA2, and the barrier BP is formed on sub-areas SA3, SA4. The opening OP transmits light and the barrier BP blocks light.

For example, as shown in FIG. 30, a first barrier electrode BE1 and a second barrier electrode BE2 are disposed in the first and the second sub-areas SA1, SA2 where the opening OP is formed. A third barrier electrode BE3 and a fourth barrier electrode BE4 are disposed in the third and the fourth sub-areas SA3, SA4 where the barrier BP is formed. The opening OP is formed by applying a first driving voltage to the first and the second barrier electrodes BE1, BE2. The barrier BP is formed by applying a second driving voltage to the third and the fourth barrier electrodes BE3, BE4 and is different from the first driving voltage.

Referring again to FIG. 29, the display panel 200, on which the liquid crystal barrier panel 470 is disposed, alternately displays two viewpoint images (e.g., a left-eye image L and a right-eye image R) using two subpixels that are consecutive in a row direction. For example, the display panel displays viewpoint images using columns of subpixels that are next to one another in the row direction. However, for convenience, only one subpixel from each column will be described.

The left-eye image L is formed by a first subpixel SP1 and a second subpixel SP2 of the display panel 200 and is emitted toward the observer's left eye L_E via the opening OP. The right-eye image R is formed by a third subpixel SP3 and a fourth subpixel SP4 of the display panel 200 and is emitted toward the observer's right eye R_E. As such, the liquid crystal barrier panel 470 may display two viewpoint images.

In a multi-viewpoint mode, the method of driving the liquid crystal barrier panel 470 is performed as follows. Referring to FIGS. 1 and 30, the conversion driver 500 applies a first driving voltage to electrode BE1, and applies a second driving voltage to barrier electrodes BE2, BE3, BE4. Accordingly, an opening OP is formed by the first barrier electrode BE1, and an barrier BP is formed by the second, the third, and the fourth barrier electrodes BE2, BE3, BE4.

On the other hand, a first, a second, a third, and a fourth viewpoint images 1, 2, 3, 4 are displayed on the first, the second, the third, and the fourth subpixels SP1, SP2, SP3, SP4 of the display panel 200, which are consecutive in a row direction. The first, the second, the third, and the fourth viewpoint images 1, 2, 3, 4 are emitted to a first, a second, a third, and a fourth viewpoint positions VW1, VW2, VW3, VW4, via the opening OP formed by the first barrier electrode BE1.

The liquid crystal barrier panel 470 may display the total of four viewpoint images 1, 2, 3, 4. If the liquid crystal barrier panel 470 for two viewpoints is driven for four viewpoints as the present exemplary embodiment, the opening OP may consist of one sub-area.

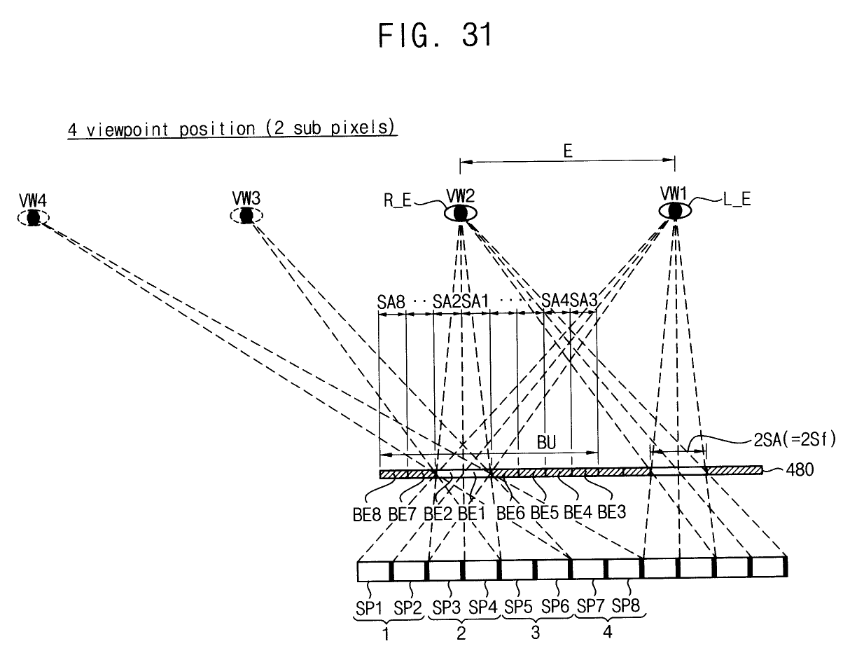

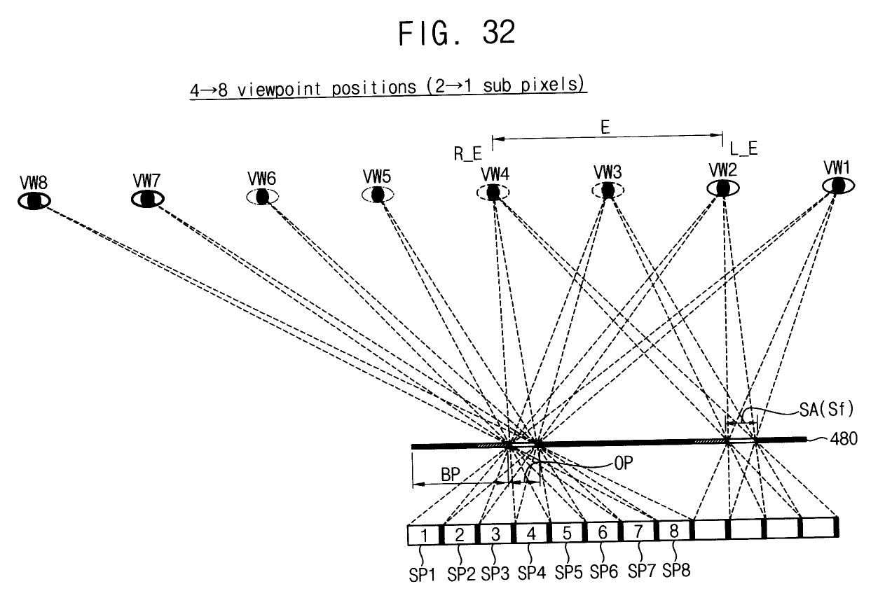

FIG. 31 is a cross-sectional view of a liquid crystal barrier panel according to still another exemplary embodiment of the present invention. FIG. 32 is a cross-sectional view illustrating multi-viewpoint driving type of the liquid crystal barrier panel of FIG. 31.

Referring to FIG. 31, the liquid crystal barrier panel 480 of the present exemplary embodiment includes a barrier unit BU for four viewpoints corresponding to eight sub-emission units. The barrier unit BU includes an opening OP and a barrier BP. The opening OP is formed on two sub-areas SA1, SA2. The barrier BP is formed on six sub-areas SA3, SA4, SA5, SA6, SA7, SA8.

For example, a first and a second barrier electrodes BE1, BE2 are disposed in the sub-areas on which the opening OP is formed. Third to eighth barrier electrodes BE3, BE4, BE5, BE6, BE7, BE8 are disposed in the sub-areas on which the barrier BP is formed. The opening OP is formed by a first driving voltage applied to the first and the second barrier electrodes BE1, BE2. The barrier BP is formed by a second driving voltage applied to the third to the eight barrier electrodes BE3, BE4, BE5, BE6, BE7, BE8, which is different from the first driving voltage.

The display panel 200 which the liquid barrier panel 480 is applied alternately displays four viewpoint images (e.g., a first viewpoint image 1, a second viewpoint image 2, a third viewpoint image 3, and a fourth viewpoint image 4) using two consecutive subpixels.

By the liquid crystal barrier panel 480, the first viewpoint image 1 is emitted is to the first viewpoint position VW1 via the opening OP. The second viewpoint image 2 is emitted to the second viewpoint position VW2 via the opening OP. The third viewpoint image 3 is emitted to the third viewpoint position VW3 via the opening OP. The fourth viewpoint image 4 is emitted to the fourth viewpoint position VW4 via the opening OP. The liquid crystal barrier panel 480 according to the present exemplary embodiment may display four viewpoint images.

In a multi-viewpoint mode, the method of driving the liquid crystal barrier panel 480 is performed as follows.

Referring to FIGS. 1 and 32, the conversion driver 500 applies a first driving voltage to the first barrier electrode BE1, and applies a second driving voltage to the second to the eighth barrier electrodes BE2, BE3, BE4, BE5, BE6, BE7, BE8. Accordingly, an opening OP is formed by the first barrier electrode BE1. A barrier BP is formed by the second to the eight barrier electrodes BE2, BE3, BE4, BE5, BE6, BE7, BE8.

On the other hand, a first, a second, a third, a fourth, a fifth, a sixth, a seventh, and an eighth viewpoint images 1, 2, 3, 4, 5, 6, 7, 8 are displayed on a first, a second, a third, a fourth, a fifth, a sixth, a seventh, and an eighth subpixels SP1, SP2, SP3, SP4, SP5, SP6, SP7, SP8 of the display panel 200 which are consecutive in a row direction.

The first to the eighth viewpoint images 1, 2, 3, 4, 5, 6, 7, 8 displayed on the eight consecutive subpixels (i.e., the first to the eighth subpixels SP1, SP2, SP3, SP4, SP5, SP6, SP7, SP8) are emitted to a first, a second, a third, a fourth, a fifth, a sixth, a seventh, and an eighth viewpoint positions VW1, VW2, VW3, VW4, VW5, VW6, VW7, VW8 via the opening OP defined by the first barrier electrode BE1.

The liquid crystal barrier panel 480 according to the present exemplary embodiment may display the total of eight viewpoint images 1, 2, 3, 4, 5, 6, 7, 8. If the liquid is crystal barrier panel 480 for four viewpoints is driven for eight viewpoints, the opening OP may consist of one sub-areas.

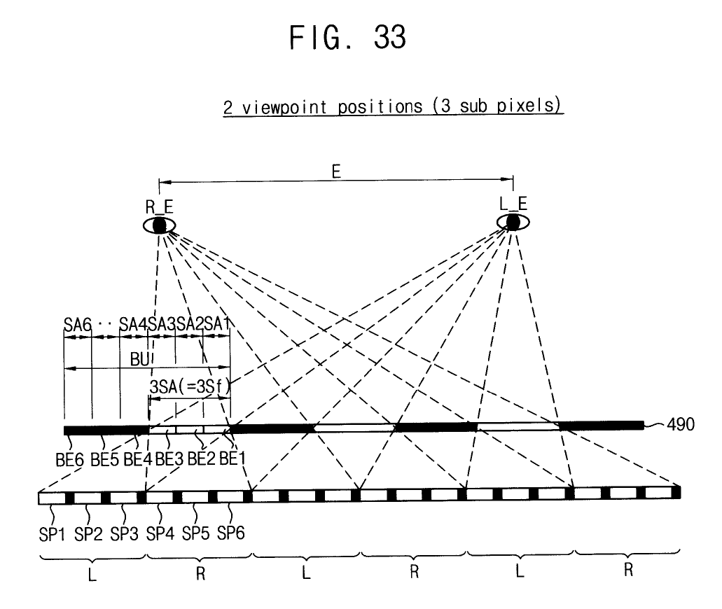

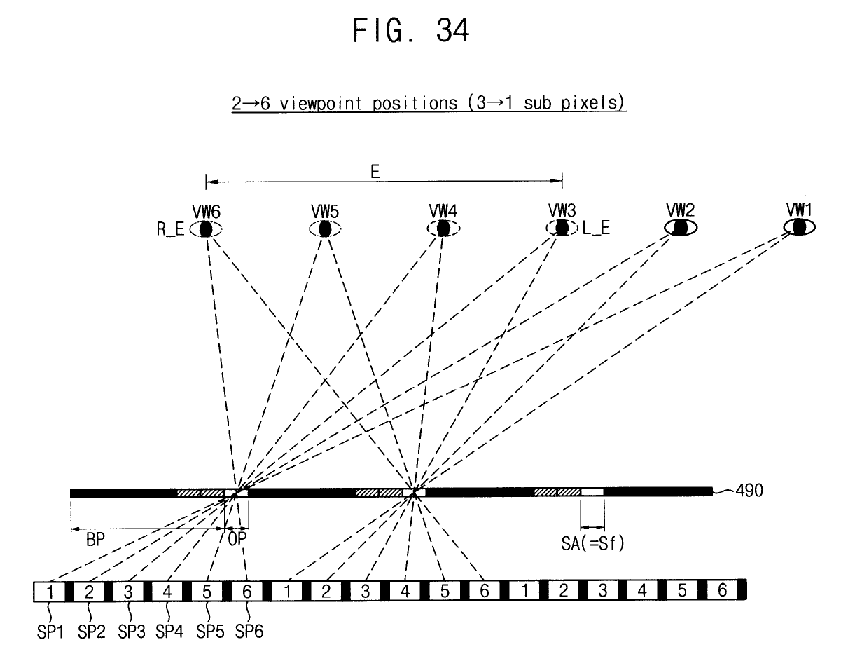

FIG. 33 is a cross-sectional view of a liquid crystal barrier panel according to still another exemplary embodiment of the present invention. FIG. 34 is a cross-sectional view illustrating multi-viewpoint driving type of the liquid crystal barrier panel of FIG. 33.

Referring to FIG. 33, the liquid crystal barrier panel 490 of the present exemplary embodiment includes a barrier unit BU for two viewpoints corresponding to six sub-areas. The barrier unit BU includes an opening OP and a barrier BP. The opening OP is formed on three sub-areas SA1, SA2, SA3. The barrier BP is formed on three sub-areas SA4, SA5, SA6.

For example, a first barrier electrode BE1, a second barrier electrode BE2, and a third barrier electrode BE3 are disposed in the sub-areas on which the opening OP is defined. A fourth barrier electrode BE4, a fifth barrier electrode BE5, and a sixth barrier electrode BE6 are disposed in the sub-areas on which the barrier BP is defined. The opening OP is formed by applying a first driving voltage to the first to the third barrier electrodes BE1, BE2, BE3. The barrier BP is formed by applying a second driving voltage to the fourth to the sixth barrier electrodes BE4, BE5, BE6, and is different from the first driving voltage.

The display panel 200 on which the liquid crystal barrier panel 490 is disposed alternately displays two viewpoint images (e.g., a left-eye image L and a right-eye image R) on three subpixels which are consecutive in a row direction.

The left-eye image L is displayed on a first subpixel SP1, a second subpixel SP2, and a third subpixel SP3 of the display panel 200, which are consecutive, and is emitted toward the observer's left eye L_E via the opening OP. The right-eye image R is displayed on a fourth subpixel SP4, a fifth subpixel SP5 and a sixth subpixel SP6 of the display panel 200, is which are consecutive, and is emitted toward the observer's right eye R_E. The liquid crystal barrier panel 490 according to the present exemplary embodiment may display two viewpoint images.

In a multi-viewpoint mode, the method of driving the liquid crystal barrier panel 490 is performed as follows. The conversion driver 500 applies a first driving voltage to the first barrier electrode BE1, and applies a second driving voltage to barrier electrodes BE2, BE3, BE4, BE5, BE6. Accordingly, an opening OP is formed by the first barrier electrode BE1, and a barrier BP is formed by barrier electrodes BE2, BE3, BE4, BE5, BE6.

On the other hand, viewpoint images 1, 2, 3, 4, 5, 6 are displayed on subpixels SP1, SP2, SP3, SP4, SP5, SP6 of the display panel 200, which are consecutive in a row direction. Viewpoint images 1, 2, 3, 4, 5, 6 displayed on subpixels SP1, SP2, SP3, SP4, SP5, SP6 are respectively emitted to viewpoint positions VW1, VW2, VW3, VW4, VW5, VW6, via the opening OP formed by the first barrier electrode BE1.

The liquid crystal barrier panel 490 may display the total of six viewpoint images 1, 2, 3, 4, 5, 6. If the liquid crystal barrier panel 490 is driven for six viewpoints, the opening OP may include one sub-area. For an ease of illustration, the opening OP is regarded as being formed on M barrier electrodes, each corresponding to M sub-areas, hereinafter.

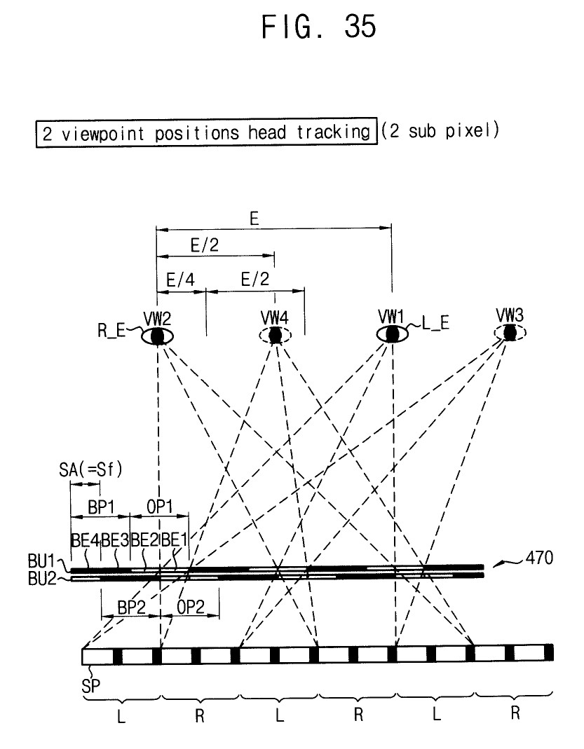

FIG. 35 is a cross-sectional view illustrating a tracking mode using the liquid crystal barrier panel 470 of FIG. 29, when the observer's position is located within the observation distance. Referring to FIGS. 14 and 35, each of a luminance profile of left-eye image LI_C and a luminance profile of right-eye image RI_C have sinusoidal shapes. The luminance profile of left-eye image LI_C is delayed by an eye distance E between a left eye and a right eye of an observer, with respect to the luminance profile RI_C of the right-eye image.

If the left eye L_E of the observer is located at a position corresponding to a peak point of the luminance profile LI_C of the left-eye image, and the right eye R_E of the observer is located at a position corresponding to a peak point of the luminance profile RI_C of the right-eye image, then the observer may receive a normal stereoscopic image without crosstalk.

If the observer's position is located within an observation distance, then the controller 100 analyzes the movement of the observer in a right-and-left direction. For example, if a left eye L_E or a right eye R_E of the observer moves by a distance E/2 of the eye distance E, then the controller 100 controls driving voltages applied to the liquid crystal barrier panel 470 to move the position of the barrier unit BU formed in the liquid crystal barrier panel 470.

Referring to FIGS. 29 and 30, if the left eye L_E and the right eye R_E of the observer are located originally at a first and a second viewpoint positions VW1, VW2, then the conversion driver 500 applies a first driving voltage to a first and a second barrier electrodes BE1, BE2, and applies a second driving voltage to a third and a fourth barrier electrodes BE3, BE4. Accordingly, an opening OP of a barrier unit BU2 is formed corresponding to the first and the second barrier electrodes BE1, BE2, and a barrier BP of the barrier unit BU2 is formed corresponding to the third and the fourth barrier electrodes BE3, BE4.

Two viewpoint images (i.e., a left-eye image L and a right-eye image R) displayed on the display panel 200 are emitted to the first and the second viewpoint positions VW1, VW2, via the opening OP. Accordingly, the left eye L_E and the right eye R_E of the observer respectively located at the first and the second viewpoint positions VW1, VW2 may respectively observe the left-eye image L and the right-eye image R.

If the tracking part 900 tracks the position of the observer's eyes moving by E/2 in a left-to-right direction, from the first and the second viewpoint positions VW1, VW2, so as to be located at a third and a fourth viewpoint positions VW3, VW4, then the conversion driver 500 applies the first driving voltage to the first and the fourth barrier electrodes BE1, BE4, and applies the second driving voltage to the second and the third barrier electrodes BE2, BE3, according to the control of the controller 100. Accordingly, a second opening OP2 of a second barrier unit BU2 is formed corresponding to the first and the fourth barrier electrodes BE1, BE4, and a second barrier BP2 of the second barrier unit BU2 is formed corresponding to the second and the third barrier electrodes BE2, BE3. The second barrier unit BU2 is moved by a width of one sub-area, which corresponds to one barrier electrode, in a left-to-right direction with respect to the first barrier unit BU1.

Two viewpoint images (i.e., the left-eye image L and the right-eye image R) displayed on the display panel 200 are emitted to the third and the fourth viewpoint positions VW3, VW4, via the second opening OP2. Accordingly, the left eye L_E and the right eye R_E of the observer, respectively located at the third and the fourth viewpoint positions VW3, VW4, may respectively observe the left-eye image L and the right-eye image R.

Although not shown, if the observer's position moves by E/2 in a right-to-left direction, the observer may receive a left-eye image and a right-eye image, by forming a second barrier unit BU2, which is moved by a width of one barrier electrode in a right-and-left direction, with respect to the first barrier unit BU1, in substantially the same way.

Again, referring to FIG. 14, if the observer's position moves more than E/4 in a right-and-left direction, the left eye L_E and the right eye R_E of the observer receive the luminance profiles corresponding to adjacent viewpoint positions. Accordingly, if the left eye or the right eye of the observer is beyond a distance of E/4 in a right-and-left direction, then the is controller 100 controls the liquid crystal barrier panel 470 to form a second barrier unit BU2, which is moved by a width of one barrier electrode from the first barrier unit BU1. The left eye L_E and the right eye R_E of the moved observer respectively receive a left-eye image L and a right-eye image R.

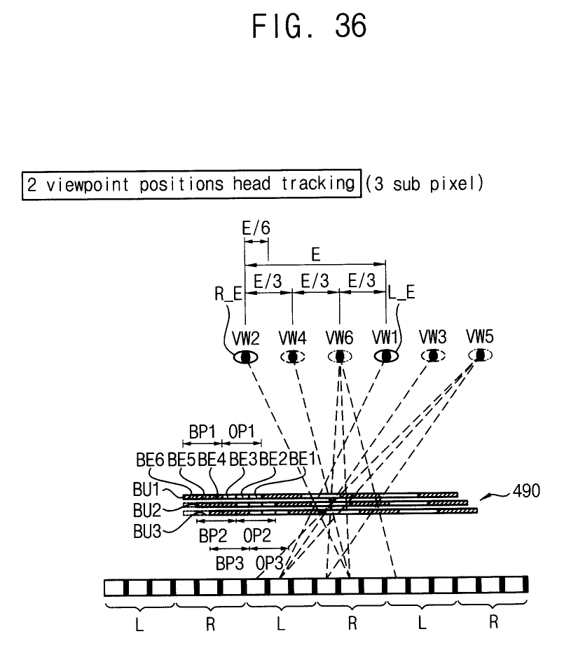

FIG. 36 is a cross-sectional view illustrating a tracking mode using the liquid crystal barrier panel of FIG. 33, when the observer's position is located within the observation distance. Referring to FIGS. 24 and 36, if the observer is located within an observation distance, the controller 100 analyzes the movement of the observer in a right-and-left direction.

For example, if a left eye L_E or a right eye R_E of the observer moves by a distance E/3 of the eye distance E, then the controller 100 controls driving voltages applied to the liquid crystal barrier panel 490 to move the position of a barrier unit BU formed in the liquid crystal barrier panel 490.

Referring to FIGS. 33 and 36, if the left eye L_E and the right eye R_E of the observer are located originally at a first and a second viewpoint positions VW1, VW2, then the conversion driver 500 applies a first driving voltage to barrier electrodes BE1, BE2, BE3, and applies a second driving voltage to barrier electrodes BE4, BE5, BE6. Accordingly, a first opening OP1 of a first barrier unit BU1 is formed corresponding to barrier electrodes BE1, BE2, BE3, and a first barrier BP1 of the first barrier unit BU1 is formed corresponding to barrier electrodes BE4, BE5, BE6.

Two viewpoint images (i.e., a left-eye image L and a right-eye image R) displayed on the display panel 200 are emitted to the first and the second viewpoint positions VW1, VW2, via the first opening OP1. Accordingly, the left eye L_E and the right eye R_E of is the observer respectively located at the first and the second viewpoint positions VW1, VW2 may respectively observe the left-eye image L and the right-eye image R.

If the tracking part 900 tracks that the observer's eyes move by E/3 in a left-to-right direction, from viewpoint positions VW1, VW2 to viewpoint positions VW3, VW4, then the conversion driver 500 applies the first driving voltage to the barrier electrodes BE1, BE2, BE6, and applies the second driving voltage to barrier electrodes BE3, BE4, BE5, according to the control of the controller 100.

Accordingly, a second opening OP2 of a second barrier unit BU2 is formed corresponding to barrier electrodes BE1, BE2, BE6, and a second barrier BP2 of the second barrier unit BU2 is formed corresponding to barrier electrodes BE3, BE4, BE5. The second barrier unit BU2 is moved by a width of one sub-area corresponding to one barrier electrode in a left-to-right direction, with respect to the first barrier unit BU1.

Two viewpoint images (i.e., the left-eye image L and the right-eye image R) displayed on the display panel 200 are emitted to viewpoint positions VW3, VW4, via the second opening OP2. Accordingly, the left eye L_E and the right eye R_E of the observer respectively located at viewpoint positions VW3, VW4 may respectively observe the left-eye image L and the right-eye image R.

On the other hand, if the tracking part 900 tracks that the observer's eyes move by 2 times E/3 in a left-to-right direction, from viewpoint positions VW1, VW2 to viewpoint positions VW5, VW6, then the conversion driver 500 applies the first driving voltage to barrier electrodes BE1, BE5, BE6, and applies the second driving voltage to barrier electrodes BE2, BE3, BE4, according to the control of the controller 100. Accordingly, a third opening OP3 of a third barrier unit BU3 is formed corresponding to barrier electrodes BE1, BE5, BE6 and a is third barrier BP3 of the third barrier unit BU3 is formed corresponding to barrier electrodes BE2, BE3, BE4. The third barrier unit BU3 is moved by a width of two sub-areas corresponding to two barrier electrodes, in a left-to-right direction, with respect to the first barrier unit BU1.

Two viewpoint images (i.e., the left-eye image L and the right-eye image R) displayed on the display panel 200 are emitted to viewpoint positions VW5, VW6, via the third opening OP3. Accordingly, the left eye L_E and the right eye R_E of the observer respectively located at viewpoint positions VW5, VW6 may respectively observe the left-eye image L and the right-eye image R.

Although not shown, if the observer's position moves by E/3 (or 2 times E/3) in a right-to-left direction, the observer may receive a left-eye image and a right-eye image by forming a second barrier unit BU2. The second barrier unit BU2 is moved by a width of one sub-area corresponding to one barrier electrode (or a third barrier unit BU3 moved by a width of two sub-areas corresponding to two barrier electrodes), in a right-to-left direction, with respect to the first barrier unit BU1, in substantially the same way.

Again, referring to FIG. 24, if the observer's position moves more than E/6 in a right-and-left direction, the left eye L_E and the right eye R_E of the observer receive the luminance profiles of adjacent viewpoint positions. Accordingly, if the left eye or the right eye of the observer is beyond a distance of E/6 in a right-and-left direction, then the controller 100 controls the liquid crystal barrier panel 490 to form a second barrier unit BU2, which is moved by a width of one sub-area corresponding to one barrier electrode from the first barrier unit BU1, and the left eye L_E and the right eye R_E of the moved observer respectively receive a left-eye image L and a right-eye image R.

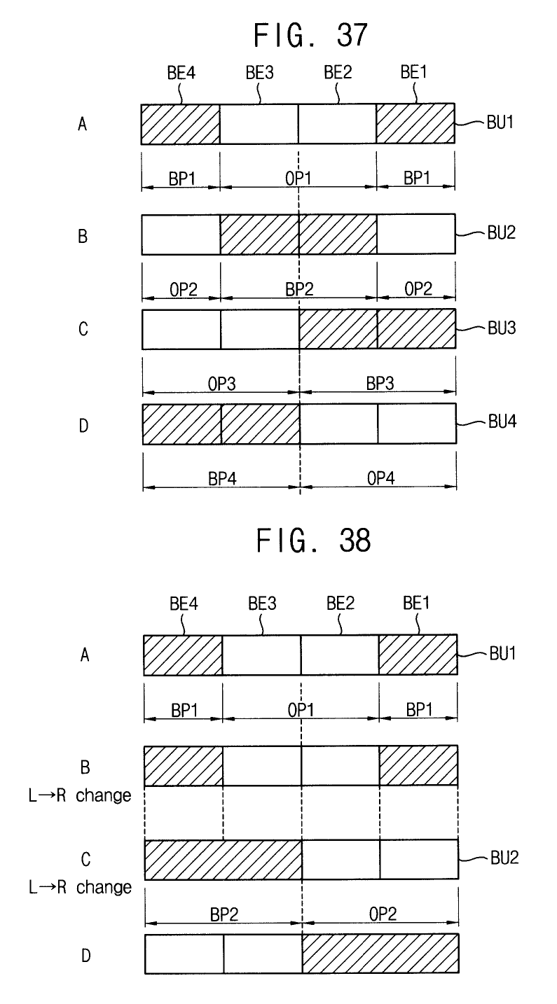

FIG. 37 is a timing chart illustrating the control of the position of a barrier is unit corresponding to the observer screen according to the liquid crystal barrier panel 470 of FIG. 30, when observed by an observer located far away. Referring to FIGS. 17, 30, and 37, the barrier unit of the liquid crystal barrier panel 470 has a striped structure as illustrated in FIG. 3A.

If the observer is located beyond the observation distance, the controller 100 computes an observer screen OVS received at the observer's position, by using an analyzing algorithm. For example, the observer screen OVS received at the right eye R_E of the observer includes a left-eye image L and a right-eye image R, as illustrated in FIG. 17.

The controller 100 divides the observer screen OVS into a first area A, a second area B, a third area C, and a fourth area D. The first area A is an area in which the right-eye image R is observed. The second area B is an area in which the left-eye image L is observed. The third area C is an area in which a first mixed image C_LR is observed at a position between the second area B and the first area A. The fourth area D is an area in which a second mixed image C_RL is observed at a position between the first area A and the second area B.

Each of the left-eye image L and the right-eye image R displayed on a screen of the display apparatus may have substantially the same width W in principle. The position of a barrier unit may be controlled differently in an area of every W/2 from the boundary between the left-eye (or the right-eye) image area and the mixed area.

Referring to FIGS. 14, 17, and 37, the first area A is an area which the right eye of the observer receives the right-eye image R. A first barrier unit BU1 of the first area A is regarded as a standard position, hereinafter. That is, the first area A of the liquid crystal barrier panel 470 is driven as the first barrier unit BU1. In the first barrier unit BU1, a first opening OP1 is defined by a first and a fourth barrier electrodes BE1, BE4, and a first barrier BP1 is defined by a second and a third barrier electrodes BE2, BE3.

The second area B is an area which the right eye R_E of the observer receives a left-eye image L. The second area B arrives at a peak point of the profile RI_C of the right-eye image, when the right eye R_E moves by 2 times E/2 in a left-to-right direction and receives the right-eye image R. A second barrier unit BU2 of the second area B moves by a width of two sub-areas corresponding to two barrier electrodes, in a left-to-right direction, with respect to the first barrier unit BU1. In the second barrier unit BU2, a second opening OP2 is formed by barrier electrodes BE1, BE4, and a second barrier BP2 is formed by barrier electrodes BE2, BE3. The second area B of the liquid crystal barrier panel 470 may operate as the second barrier unit BU2 for the right eye R_E of the observer to receive the right-eye image R of the second area B.

The third area C is an area which the right eye R_E of the observer receives the first mixed image C_LR including the left-eye image and the right-eye image. The third area C arrives at a peak point of the profile of the right-eye image RI_C, when the right eye R_E moves by 3 times E/2 in a left-to-right direction, to receive the right-eye image R. A third barrier unit BU3 of the third area C moves by a width of three sub-areas corresponding to three barrier electrodes, with respect to the first barrier unit BU1 of the first area A. In the third barrier unit BU3, a third opening OP3 is defined by third and fourth barrier electrodes BE3, BE4, and a third barrier BP3 is defined by a first and a second barrier electrodes BE1, BE2. The third area C of the liquid crystal barrier panel 470 may operate as the third barrier unit BU3, for the right eye R_E of the observer to receive the right-eye image R in the third area C.

The fourth area D is an area which the right eye R_E of the observer receives the second mixed image C_RL including the left-eye image and the right-eye image. The third area C arrives at a peak point of the profile of the right-eye image RI_C when the right is eye R_E moves by 1 times E/2 in a left-to-right direction, to receive the right-eye image R. A fourth barrier unit BU4 of the fourth area D moves by a width of one sub-area corresponding to one barrier electrode, with respect to the first barrier unit BU1 of the first area A. In the fourth barrier unit BU4, a fourth opening OP4 is defined by first and second barrier electrodes BE1, BE2, and a fourth barrier BP4 is defined by third and fourth barrier electrodes BE3, BE4. The fourth area D of the liquid crystal barrier panel 470 may operate as the fourth barrier unit BU4, for the right eye R_E of the observer to receive the right-eye image R in the fourth area D.

As mentioned above, the left eye L_E or the right eye R_E of the observer located beyond the observation distance may respectively receive the left-eye image L or the right-eye image R, by controlling the position of the barrier unit of the liquid crystal barrier panel.

FIG. 38 is a timing chart illustrating the control of the position of a barrier unit corresponding to an observer screen, according to still another exemplary embodiment of the present invention. Referring to FIG. 38, a barrier unit or a barrier electrode of the liquid crystal barrier panel has a striped structure as illustrated in FIG. 3A. The controller 100 controls a left-eye image (or a right-eye image) displayed on the display panel and the position of the barrier unit, on the basis of the left-eye image (or the right-eye image) and a mixed image received at each of the first, the second, the third, and the fourth areas A, B, C, D.

For example, the first area A and the second area B are different viewpoint areas in which the right eye R_E of the observer receives a right-eye image R and a left-eye image L, respectively. The third area C and the fourth area D area are mixed areas in which the right eye R_E of the observer receives a first mixed image C_LR and a second mixed image C_RL, respectively.

Referring to FIGS. 14, 17, and 38, the first area A and the second area B are areas in which the right eye R_E of the observer receives the right-eye image R and the left-eye image L. The controller 100 sets a first barrier unit BU1 of the first area A as a standard position. In the first barrier unit BU1, a first opening OP1 is defined by a first and a fourth barrier electrodes BE1, BE4, and a first barrier BP1 is defined by second and third barrier electrodes BE2, BE3. The right eye R_E of the observer receives the right-eye image R, via the first barrier unit BU1 in the first area A.

In contrast, in the second area B, the right eye R_E of the observer receives the left-eye image L, via the first barrier unit BU1. Accordingly, the controller 100 renders image data to display the right-eye image R on the display panel corresponding to the second area B. As a result, the right eye R_E of the observer may receive the right-eye image R, via the first barrier unit BU1, by displaying the right-eye image R in an area of the display panel corresponding to the second area B.

The third area C and the fourth area D are areas through which the right eye R_E of the observer receives the first and the second mixed images C_LR, C_RL, respectively. The controller 100 moves a second barrier unit BU2 of the third area C and the fourth area D, with respect to the position of the first barrier unit BU1.

For example, if the second barrier unit BU2 moves by a width of three sub-areas corresponding to three barrier electrodes in a right-to-left direction, with respect to the first barrier unit BU1, in the second barrier unit BU2, a second opening OP2 is defined by a first and a second barrier electrodes BE1, BE2, and a second barrier BP2 is defined by a third and a fourth barrier electrodes BE3, BE4.

When the first mixed image C_LR displayed on the third area C is moved by 3 times E/2 in a left-to-right direction, by the second barrier unit BP2, the right eye R_E of the observer receives the left-eye image L. The controller 100 renders image data to display the right-eye image R in an area of the display panel corresponding to the third area C. Accordingly, the right eye R_E of the observer may receive the right-eye image R in the third area C.

If the second barrier unit BU2 moves by a width of three barrier electrodes in a right-to-left direction, with respect to the first barrier unit BU1, the second mixed image C_RL displayed on the fourth area D is observed as the right-eye image R, which is moved by 3 times E/2 in a left-to-right direction by the second barrier unit BU2. Accordingly, the right eye R_E of the observer may receive the right-eye image R in the fourth area D.

According to the present exemplary embodiment, eyes (a left eye or a right eye) of the observer may receive corresponding viewpoint images by controlling the position of the barrier unit in two ways, according to the different viewpoint areas and the mixed areas, and by controlling image data on the basis of the two methods of controlling the barrier unit.

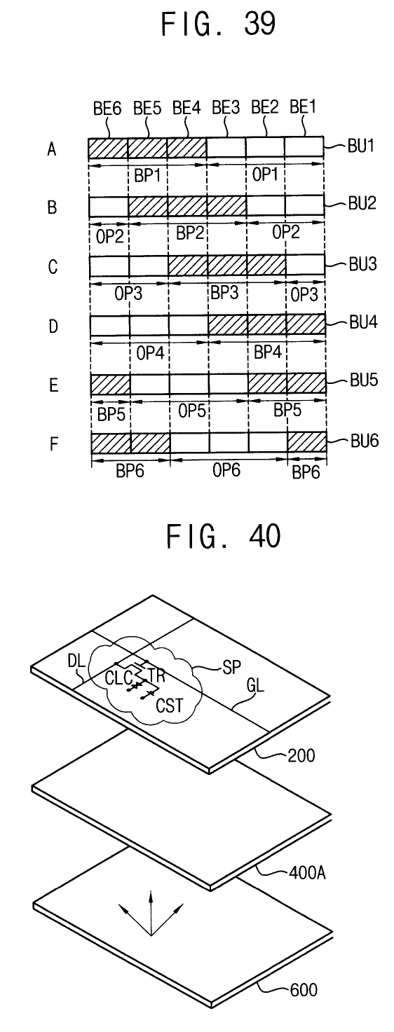

FIG. 39 is a timing chart illustrating the control of the position of a barrier unit corresponding to the observer screen using the liquid crystal barrier panel of FIG. 33, when observed by an observer. Referring to FIGS. 24, 25, and 39, the liquid crystal barrier panel 490 has a striped structure as illustrated in FIG. 3A. For example, the controller 100 computes an observer screen OVS including a left-eye image L and a right-eye image R received at the observer's right eye R_E.

In addition, the controller 100 divides the observer screen OVS into a left-eye (or a right-eye) image area and a mixed image area. For example, the controller 100 determines a central part of the left-eye image LA (or a central part of the right-eye image RA) and a boundary part between the left-eye image area LA and the right-eye image area RA. The is controller 100 divides the area between the central part and the boundary part into three parts. As a result, the controller 100 divides the observer screen OVS into a first area A, a second area B, a third area C, a fourth area D, a fifth area E, and a sixth area F.

Each area of the left-eye image L and the right-eye image R, which are displayed on a screen of the display apparatus, may have substantially the same width W in principle. The controller 100 may control the position of a barrier unit differently over a distance of every W/3 from the boundary of the left-eye (or the right-eye) image area and the mixed image area.

The first area A is an area in which the right eye of the observer receives a right-eye image R. A first barrier unit BU1 is regarded as being in a standard position. In the first barrier unit BU1, a first opening OP1 is defined by first, second, and third barrier electrodes BE1, BE2, BE3 of the first area A. A first barrier BP1 is defined by fourth, fifth, and sixth barrier electrodes BE4, BE5, BE6 of the first area A. The first area A of the liquid crystal barrier panel 490 operates as the first barrier unit BU1. Accordingly, the right eye R_E of the observer receives the right-eye image R in the first area A.

The second area B is an area in which the right eye R_E of the observer receives a first mixed image C_RL1. The second area B arrives at a peak point of the luminance profile RI_C of the right-eye image, when moved by 1 times E/3 in a left-to-right direction, to receive the right-eye image R. A second barrier unit BU2 of the second area B moves by a width of one sub-area corresponding to one barrier electrode in a left-to-right direction, with respect to the first barrier unit BU1. In the second barrier unit BU2, a second opening OP2 is defined by the first, the second, and the sixth barrier electrodes BE1, BE2, BE6, and a second barrier BP2 is defined by the third, the fourth, and the fifth barrier electrodes BE3, BE4, BE5. The second area B of the liquid crystal barrier panel 490 operates as the second barrier unit BU2, for the right eye R_E of the observer to receive the right-eye image R in the second area B.

The third area C is an area in which the right eye R_E of the observer receives a second mixed image C_RL2. The third area C arrives at a peak point of the luminance profile RI_C of the right-eye image, when moved by 2 times E/3 in a left-to-right direction to receive the right-eye image R. A third barrier unit BU3 of the third area C moves by a width of two sub-areas corresponding to two barrier electrodes in a left-to-right direction, with respect to the first barrier unit BU1. In the third barrier unit BU3, a third opening OP3 is defined by the first, the fifth, and the sixth barrier electrodes BE1, BE5, BE6, and a third barrier BP3 is defined by the second, the third, and the fourth barrier electrodes BE2, BE3, BE4. The third area C of the liquid crystal barrier panel 490 operates as the third barrier unit BU3 for the right eye R_E of the observer to receive the right-eye image R in the third area C.

The fourth area D is an area in which the right eye R_E of the observer receives a left-eye image L. The fourth area D arrives at a peak point of the luminance profile RI_C of the right-eye image, when moved by 3 times E/3 in a left-to-right direction, to receive the right-eye image R. A fourth barrier unit BU4 of the fourth area D moves by a width of three sub-areas corresponding to three barrier electrodes in a left-to-right direction, with respect to the first barrier unit BU1. In the fourth barrier unit BU4, a fourth opening OP4 is defined by the fourth, the fifth, and the sixth barrier electrodes BE4, BE5, BE6, and a fourth barrier BP4 is defined by the first, the second, and the third barrier electrodes BE1, BE2, BE3. The fourth area D of the liquid crystal barrier panel 490 operates as the fourth barrier unit BU4, for the right eye R_E of the observer to receive the right-eye image R in the fourth area D.

The fifth area E is an area in which the right eye R_E of the observer is receives a third mixed image C_LR1. The fifth area E arrives at a peak point of the luminance profile RI_C of the right-eye image when moved by 4 times E/3 in a left-to-right direction to receive the right-eye image R. A fifth barrier unit BU5 of the fifth area E moves by a width of four sub-areas corresponding to four barrier electrodes in a left-to-right direction with respect to the first barrier unit LS1. In the fifth barrier unit BU5, a fifth opening OP5 is defined by the third, the fourth, and the fifth barrier electrodes BE3, BE4, BE5, and a fifth barrier BP5 is defined by the first, the second, and the sixth barrier electrodes BE1, BE2, BE6. The fifth area E of the liquid crystal barrier panel 490 operates as the fifth barrier unit BU5 for the right eye R_E of the observer to receive the right-eye image R in the fifth area E.

The sixth area F is an area in which the right eye R_E of the observer receives a fourth mixed image C_LR2. The sixth area F arrives at a peak point of the luminance profile RI_C of the right-eye image when moved by 5 times E/3 in a left-to-right direction to receive the right-eye image R. A sixth barrier unit BU6 of the sixth area F moves by a width of five sub-areas corresponding to five barrier electrodes in a left-to-right direction with respect to the first barrier unit BU1. In the sixth barrier unit BU6, a sixth opening OP6 is defined by the two, the third, and the fourth barrier electrodes BE2, BE3, BE4, and a sixth barrier BP6 is defined by the first, the fifth, and the sixth barrier electrodes BE1, BE5, BE6. The sixth area F of the liquid crystal barrier panel 490 operates as the sixth barrier unit BU6 for the right eye R_E of the observer to receive the right-eye image R in the sixth area F.

As mentioned above, the left eye L_E or the right eye R_E of the observer located beyond the observation distance may respectively receive the left-eye image L or the right-eye image R by controlling the position of the barrier unit of the liquid crystal barrier panel. Although not shown in figures, if a barrier unit of the liquid crystal barrier panel has a tilted structure illustrated in FIG. 3B, the eyes of the observer may receive corresponding viewpoint images by controlling image data and the position of the barrier unit in substantially the same way as the liquid crystal lens panel illustrated above.

According to the liquid crystal barrier panels of the exemplary embodiments above, the opening rate of a unit barrier is 1/N, when N viewpoint images are displayed be every M consecutive subpixels, and an opening is defined corresponding to 2×Sf on every barrier unit having a length of M×N×Sf.

In a multi-viewpoint mode, an opening having a length of M×N converts M minus 1 unit areas (or sub-areas) into blocking states, and at the same time, displays M×N viewpoint images on consecutive M×N subpixels to increase the number of viewpoints. In a tracking mode, an opening having a length of M×N moves the position of an opening having a length of M×Sf in consecutive M×N unit areas (M×N×Sf), divided according to the observer's moving direction, with respect to the display panel for N viewpoints that alternately displays a left-eye image and a right-eye image on every N subpixels.

If an opening has a length of M×N, the position of the opening moves by a width of one sub-areas according to the observer's moving direction as one eye (a left eye or a right eye) of the observer moves more than ±E/(M×N) in a right-and-left direction from a peak point, when the eye of the observer located within an observation distance is positioned at a peak point of the luminance profile. In addition, if the observer moves by E/M in a right-or-left direction from a standard position, the position of the opening moves by a width of one unit (one sub-area).

Each of a left-eye image L and a right-eye image R, included in an observer screen for an observer located beyond an observation distance, may have substantially the same width W. The position of the opening may be controlled differently in an area of every W/M from the boundary between the left-eye image area and the right-eye image area. If the opening has a length of M×N corresponding to M×N subpixels, then the observer may receive the left-eye image or the right-eye image in all areas of the observer screen, by controlling the position of M×N-type openings.

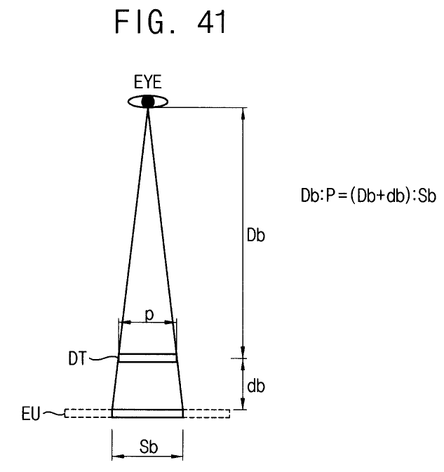

FIG. 40 is a perspective view of display apparatus according to another exemplary embodiment of the present invention. FIG. 41 is a cross-sectional view illustrating an emission unit included in the dynamic conversion panel of FIG. 40. Referring to FIG. 40, all elements are substantially the same as those of FIGS. 1 and 2, except for the position of a dynamic conversion panel. Thus, a description of similar elements is omitted.

The display apparatus includes a display panel 200, a dynamic conversion panel 400A, and a light source 600. The dynamic conversion panel 400A is disposed on a light-emitting side of the light source 600 and is disposed between the display panel 200 and the light source 600.

The dynamic conversion panel 400A operates in a transmission mode to transmit the light from the light source 600 and in a conversion mode to convert the direction of light emission. For example, in a two-dimensional image mode, in which the display apparatus displays two-dimensional images, the dynamic conversion panel 400A operates in a transmission mode to provide the light to the display panel 200 to display a two-dimensional image. In addition, in a three-dimensional image mode, in which the display apparatus displays three-dimensional images using at least two viewpoint images, the dynamic conversion panel 400A operates in a conversion mode to provide the light emitted toward at least two viewpoint positions, for the display panel 200 to display a three-dimensional image.

The dynamic conversion panel 400A includes an emission unit to emit the light emitted toward at least two viewpoint positions in a three-dimensional image mode. The emission unit may be operated by at least one element electrode. For example, if the dynamic conversion panel 400A is a liquid crystal lens panel, the emission unit may be a lens structure, and the element electrode may be at least two lens electrodes. Alternatively, if the dynamic conversion panel 400A is a liquid barrier panel, the emission unit may be a barrier unit, and the element electrode may be at least one barrier electrode.

Referring to FIG. 41, a unit area Sb is a moveable area within an emission unit EU. The unit area Sb may be determined by a pitch of the dots DT, a distance between the dots DT and the emission unit EU, and an observation distance Db of the emission unit EU.

The method of driving the display apparatus according to the present exemplary embodiment is substantially the same as the exemplary embodiments illustrated in FIGS. 1 to 39, except that the unit area Sf is changed to the unit area Sb. Thus, a detailed description of similar elements is omitted.

According to the liquid crystal lens panels of the present exemplary embodiments, if the left eye or the right eye of the observer is located at a peak of the luminance profile and within the observation distance of the luminance profile, the position of a lens structure is moved by a width of at least one lens electrode corresponding to a moving direction of the observer, when the observer moves more than ±E/(2M) in a right or left direction with respect to the peak, under a condition that the lens structure has a length of 2M times N, where M is the number of sub-areas included in a lens unit and N is the number of viewpoint images. That is, M is the number of lens electrodes formed in an area of the lens unit. In addition, if an observer moves by E/M in a right-or-left direction from a standard position, the position of the is lens structure moves by a width of one lens electrode. If the liquid crystal lens panel is disposed between the display panel and the light source part, the position of the lens structure moves in an opposite direction to that of the case where the liquid crystal lens panel is disposed in an upper part of the display panel.

Each of a left-eye image L and a right-eye image R, included in an observer screen observed by an observer located beyond an observation distance, may have substantially the same width W. The position of the lens structure may be controlled differently in an area of every W/M, from the boundary between the left-eye image area and the right-eye image area.

If the lens structure has a length of 2 times M corresponding to two subpixels, then the observer may receive the left-eye image or the right-eye image in all area of the observer screen by controlling the position of 2×M types of lens structures. According to the liquid crystal barrier panels of the present exemplary embodiments, the opening rate of the barrier unit is 1/N when N viewpoint images are displayed on every M consecutive subpixels and an opening is defined corresponding to 2×Sb on every barrier unit having a length of M×N×Sb.

In a multi-viewpoint mode, an opening having a length of M×N converts M minus 1 unit area (sub-areas) into blocking states, and at the same time, displays M×N viewpoint images on consecutive M×N subpixels to increase the number of viewpoint images. In a tracking mode, an opening having a length of M×N moves the position of an opening having a length of M×Sb in consecutive M×N distances (M×N×Sb) divided according to the observer's moving direction with respect to the display panel for N viewpoints, which alternately displays a left-eye image and a right-eye image on every N subpixels.

If an opening has a length of M×N, the position of the opening moves by a width of one sub-area according to the observer's moving direction as one eye (a left eye or a is right eye) of the observer moves more than ±E/(M×N) in a right-and-left direction from a peak point when the eye of the observer located in an observation distance is positioned at a peak point of the luminance profile. In addition, if a head of the observer moves by E/M in a right-and-left direction from a standard position, the position of the opening moves by a width of one unit (or a sub-areas). If the liquid crystal barrier panel is disposed between the display panel and the light source part, the position of the barrier unit moves in an opposite direction to that of the case where the liquid crystal barrier panel is disposed in an upper part of the display panel.

Each of a left-eye image L and a right-eye image R included in an observer screen which the observer located beyond an observation distance observes may have substantially the same width W. The position of the opening may be controlled differently in an area of every W/M from the boundary between the left-eye image area and the right-eye image area.

If the opening has a length of M×N corresponding to M×N subpixels, then the observer may receive the left-eye image or the right-eye image in all area of the observer screen by controlling the position of M×N types of openings.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of displaying three-dimensional stereoscopic image comprising:
forming N viewpoint images using a row of consecutive sub-pixels of a display panel;
emitting the N viewpoint images through an emission unit of a dynamic conversion panel, the emission unit comprising an emission area through which the view point images are projected, the emission area comprising M sub-areas;
determining whether a single observer or M observers are present;
controlling the emission unit to emit the N viewpoint images to N×M viewpoint positions, when the M observers are detected; and
detecting a change in position of the single observer from a first position to a second position and then moving the emission unit to emit the N viewpoint images to the second position, when the single observer is detected
wherein M and N are natural numbers greater than 1.

2. The method of claim 1, further comprising:
moving the emission unit sequentially M times by one sub-area during one frame, when the M observers are detected.

3. The method of claim 1, further comprising:
reducing the emission area to a constituent unit when the observers are plural, the constituent emission unit comprising the M sub-areas, the constituent unit comprising 1/M sub-areas; and
displaying N×M viewpoint images on N×M dots which are consecutive in a row direction.

4. The method of claim 1, wherein when the single observer is determined to be disposed within a set observation distance, the moving of the emission unit comprises moving the emission unit by one sub-area according to a direction in which the observer moved, when the observer's position moves more than ±E/(N×M) in a right-and-left direction, E being a distance between the eyes of the single observer.

5. The method of claim 4, further comprising:
moving the emission unit by a width of one sub-area when the observer's position moves by E/M in a horizontal direction.

6. The method of claim 1, wherein the single observer is determined to be disposed beyond a set observation distance, the method further comprises:
computing an observer screen provided to the single observer;
dividing the observer screen into N×M areas having widths of W/M on the basis of a width W of viewpoint images included in the observer screen; and
controlling the position of the emission unit by a unit of the sub-area.

7. The method of claim 1, wherein the single observer is disposed beyond a set observation distance designed, the method further comprises:
computing an observer screen provided to the single observer;
dividing the observer screen into N×M areas having widths of W/M on the basis of a width W of viewpoint images of the observer screen;
moving the emission unit to M types of positions with respect to the N×M areas; and
controlling image data by a subpixel unit to display the viewpoint image corresponding to the observer's eyes on the display panel on the basis of the emission units, the emission units being moved to the M types of positions.

8. A display apparatus comprising:
a display panel configured to display N viewpoint images using N sub-pixels that are disposed consecutively in a row direction; and
a dynamic conversion panel configured to form an emission unit, the emission unit comprising an emission area comprising M sub-areas, the dynamic conversion panel to control the sub-areas to drive in a multi-viewpoint mode which N viewpoint images are emitted to N×M viewpoint positions when observers are plural, and the dynamic conversion panel to move the emission unit to a position determined according to an observer's position to drive in a tracking mode in which N viewpoint images are emitted to the observer's position when the observer is single,
wherein M and N are natural numbers.

9. The display apparatus of claim 8, wherein the dynamic conversion panel comprising:
a first substrate comprising lens electrodes;
an opposing second substrate comprising a counter electrode; and
a liquid crystal layer disposed between the first substrate and the second substrate, and
wherein driving voltages are applied to the lens electrodes to form lens structures when driven in a three-dimensional stereoscopic image mode, the lens structures comprising N lens units, each of the lens units comprising M sub-areas, and
wherein M and N are natural numbers.

10. The display apparatus of claim 9, wherein the lens structures move sequentially M times by one sub-area with respect to M sub-areas during one frame when driven in the multi-viewpoint mode.

11. The display apparatus of claim 10, wherein:
the display panel displays N viewpoint images on N consecutive subpixels; and
the display apparatus displays M×N viewpoint images by the dynamic conversion panel and the display panel, the dynamic conversion panel being driven at a speed of M, the display panel displaying the N viewpoint images.

12. The display apparatus of claim 9, wherein, in the tracking mode:
an observer's position is located in an observation distance; and
the lens structures move by one sub-area corresponding to a moving direction of the observer when the observer's position moves more than ±E/(N×M) in a right-and-left direction.

13. The display apparatus of claim 12, wherein when the observer's position moves by E/M in a horizontal direction, the lens structures move by one sub-area.

14. The display apparatus of claim 9, wherein, in the track mode and when an observer's position is located beyond an observation distance:
an observer screen received on the observer's eyes are divided into N×M areas on the basis of a width W of a viewpoint image; and
positions of the lens structures corresponding each to the areas are controlled by a unit of the sub-area, the observer screen having a width of W/M, the viewpoint image being included in the observer screen.

15. The display apparatus of claim 9, wherein, in the tracking mode and when an observer's position is located beyond an observation distance:
an observer screen provided to the observer is divided into N×M areas on the basis of a width W of a viewpoint image, the observer screen having a width of W/M, the viewpoint image being included in the observer screen,
the lens structures are moved to M types of positions with respect to the N×M areas, and
image data are controlled by a unit of subpixels to display the viewpoint image corresponding to the observer's eyes on the basis of the lens structures, the lens structures being moved to M positions.

16. The display apparatus of claim 8, wherein the dynamic conversion panel comprising:
a first substrate comprising barrier electrodes;
an opposing second substrate comprising a facing electrode; and
a liquid crystal layer disposed between the first substrate and the second substrate, wherein a driving voltage is applied to the barrier electrodes for the dynamic conversion panel to form openings when driven in a three-dimensional stereoscopic image mode, the openings comprising M sub-areas, and
wherein M is a natural number.

17. The display apparatus of claim 16, wherein the opening corresponds to 1/M sub-areas in the multi-viewpoint mode.

18. The display apparatus of claim 17, wherein the display panel displays M×N viewpoint images on M×N subpixels, the subpixels being consecutive in a row direction, the opening corresponds to one sub-area, and a light shielding part adjacent to the opening corresponds to M−1 sub-areas.

19. The display apparatus of claim 16, wherein, in the tracking mode,
(a) when an observer's position is located within an observation distance, and
(i) a position of the opening moves by one sub-area corresponding to a moving direction of the observer, when the observer's position moves by more than ±E/(N×M) in a right-and-left direction, and
(ii) the position of the opening moves by one sub-area when the observer's position moves by E/M in a horizontal direction from an observation position, and
(b) when the observer's position is located beyond the observation distance, and an observer screen projected to the observer is divided into N×M areas on the basis of a width W of a viewpoint image, and at least one of the cases which the position of the opening corresponding each to the areas is controlled by a unit of the sub-area is selected according to the observer's position, the observer screen having a width of W/M, the viewpoint image being included in the observer screen.

20. The display apparatus of claim 16, wherein, in the tracking mode and when an observer's position is located beyond an observation distance:
an observer screen received on the observer's eyes is divided into N×M areas on the basis of a width W of a viewpoint image;
the openings are moved to M positions with respect to the N×M areas; and
image data is controlled to display the viewpoint image corresponding to the observer's eyes on the display panel on the basis of the openings, the observer screen having a width of W/M, the viewpoint image being included in the observer screen, the openings being moved to the M types of positions.
